(19) United States
(12) Patent Application Publication
(10) Pub. No.: US 2026/0279175 A1
(43) Pub. Date: Sep. 17, 2026

(54) AUTOMATED ELECTRONIC SECURITY SYSTEM

(71) Applicant: GROTE INDUSTRIES, INC., MADISON, IN (US)

(72) Inventor: ADAM SLADE, MADISON, IN (US)

(73) Assignee: GROTE INDUSTRIES, INC., MADISON, IN (US)

(21) Appl. No.: 19/079,961

(22) Filed: Mar. 14, 2025

(51) Int. Cl. G08B 13/12; B60R 25/01; B60R 25/10

(52) U.S. Cl. CPC G08B 13/12; B60R 25/01; B60R 25/1001

(57) ABSTRACT

An automated electronic security system that includes a digital security seal. The security seal may be coupled to a trailer, shipping container, or individual item. The security seal optionally communicates with a master control circuit in a trailer to notify a remote monitoring service when a seal is tampered with. The seal may communicate with a master control circuit via a trailer wiring system using an optional adapter to provide timely status updates. The real-time status of the seal may be monitored by the master control circuit. When the seal is damaged or broken, an alert may be sent to the monitoring service, which is optionally configured to send a notification to a remote monitoring service. The remote monitoring service optionally applies geographical boundary data and/or triggering rules to determine when an alert should be sent based on geographical locations.

### BACKGROUND

The present disclosure relates generally to a security seal that interacts with a reporting system to detect and report when a trailer, container, or load has been tampered with. Attaching a security tag, or seal to a load is common when goods are shipped. Such tags may be affixed to individual items, or to a trailer, shipping container, or other item and may be used as evidence of tampering if the seal is broken. Most such seals, however, cannot report when the seal is broken, where it was broken, or any other circumstances surrounding the possible unauthorized access to the sealed container. In some instances, seals may be broken by authorized personnel, a scenario that is difficult or impossible to distinguish from malicious or unintentional tampering.

### SUMMARY

Disclosed is security seal and security system for protecting cargo during transit and storage. The system may be useful in a range of vehicles, including buses, trailers, ships, barges, and aircraft, as well as for individual items like shipping containers, crates, bags, and boxes either in transit or in storage. The security seal is optionally applied directly to a trailer, shipping container, and the like, or individual cargo items directly. The security seal may include, or be used with, an optional accompanying adapter to allow communication with the security system via an existing wiring system such as may be found in a trailer. In another aspect, the security seal optionally functions as a standalone trailer component without the need for a separate adapter, and can be directly plugged into the trailer wiring system of a trailer that may be coupled to a towing vehicle.

In another aspect, the trailer wiring system connects some or all of the trailer components to a master control circuit. The master control circuit optionally acts as a processing and communication node on the communication network facilitated by the trailer wiring system. The master control circuit optionally manages communications and power distribution to the components of the trailer. Trailer components, include but are not limited to, lights, cameras, ABS controllers, various sensors (tire pressure, cargo, motion, proximity) and the like, and can be mounted internally, externally, or in any combination thereof.

The trailer wiring system optionally transmits power and data signals to and from these trailer components, thus facilitating communication between them, and between a nosebox that optionally contains the master control circuit. This communication network may extend beyond the trailer itself, connecting to the towing vehicle and potentially to other trailers in a multi-trailer configuration. The towing vehicle, in turn, may communicate with multiple trailers through logical, physical, electrical, or wireless connections.

In another aspect, the disclosed security seal may be coupled to a wide range of locking or closure mechanisms for selectively securing containers, doors, gates, cables, straps, or any lock mechanism coupled thereto. The lock mechanism optionally secures the closure but also serves as mount point for the security seal and a point where detection of unauthorized access may be captured.

The master control circuit interacts with the security seal and/or adapter, and other trailer components via the wiring system, to manage power distribution and data flow between components in the trailer and the towing vehicle. The master control circuit optionally monitors the health of the components, detecting outages and collecting status information from them periodically and in real time.

This information may be periodically transmitted to remote servers of the security service for real-time monitoring and analysis of the trailer. In another aspect, the master control circuit is optionally configured to generate status updates, security alerts, and other information which may be sent to the remote monitoring service via a wired or wireless communication link. The master control circuit may be operable to initiate and actively maintain this communication link, and to facilitate continuous monitoring of the security seals other trailer components.

The master control circuit may be operable to detect and report security breaches, and to send security alerts to the remote monitoring service when a security seal is broken, tampered with, or if the connection between the seal, the adapter (if one is present), and the master control circuit is lost. These alerts may include the geographical location of the event, providing valuable information for response and investigation.

In another aspect, lock mechanisms that the security seal may be applied to are designed for controlled selective access allowing authorized personnel to open and close the secured closure as needed. The lock mechanisms may incorporate or define openings for a portion of the security seal (such as a cable) to pass through. Thus, if the cable is damaged, forcibly removed, severed, or otherwise tampered with, to gain unauthorized access to the container, the security seal and/or the adapter of the present disclosure is operable to detect this unauthorized access and to report it.

The security seal is optionally configured to detect and report tampering events, thus allowing remote systems or interested parties to be notified about any unauthorized access to the trailer, its subsystems, or individual cargo items. In one aspect, tampering with the lock mechanism may be captured using an analog circuit, and the adapter and/or the security seal of the present disclosure may be configured to convert data about this event to a digital communication signal and send it to the master control circuit. The wiring system optionally communicates using the Control Area Network (CAN), or the Local Interconnect Network (LIN) protocol, to ensure reliable communication between components. The master control circuit and other trailer components may be electrically connected to the control area network and may operate as peers (nodes) on this network.

The security seal optionally incorporates an electrically conductive or resistive element, such as a cable and resistor, or a cable with conductive and/or resistive properties, and the like which may be monitored for changes. The adapter optionally acts as an intermediary between the security seal and the trailer wiring, monitoring the seal's electrical resistance for any signs of tampering or breakage. The adapter may be configured to transmit data about the detected breach to the master control circuit, which may then log and/or relay information about the breach to a remote monitoring service, server, personal device, the towing vehicle, or any combination thereof.

The system optionally includes multiple layers of communication and monitoring. Information from the security seal and/or the adapter can be sent to personal computing devices and a remote monitoring service. The security seal itself optionally includes a cable with connectors, which are electrically conductive. These connectors may be used to establish a secure connection between the cable, adapter, and security seal. The cable may be arranged and configured to pass through the locking assembly, thus allowing detection if the locking assembly is tampered with.

The adapter optionally houses various components, including memory for storing an identifier, circuitry for establishing and maintaining the communication link with the master control circuit, input connectors, an optional data connector, and a power connector. This allows the adapter to receive power, transmit data, and communicate with the nosebox and master control circuit. The adapter may also send updates and alerts with information about changes in the security cable's continuity. If the continuity of the cable and the security seal is broken, an update with relevant information such as the date, time, location on the trailer, ID of the seal, and/or the location of the seal on the earth may be passed to the master control circuit. Communication with the master control circuit may be via wired or wireless communication protocols, utilizing technologies like CAN, Wi-Fi and Bluetooth. As noted here, an adapter of the present disclosure may also include location-finding circuits operable to determine the location of the adapter on the surface of the earth via any suitable location finding system. This data may be included in the status updates or alerts.

In another aspect, the adapter (or a security seal that incorporates adapter functionality) may continuously monitor resistance data comparing it to predefined thresholds. Either the raw data, or notification of data points that are outside the predefined thresholds, or both, may be sent by the adapter to the master control circuit. Thus, either the master control circuit, the adapter, or both, may process continuity or resistance data to determine when a security seal of the present disclosure has been breached or tampered with.

The master control circuit may be equipped with a memory, a processor, control logic, and location-finding circuitry configured to communicate with any suitable location finding system. If a security breach is detected, the master control circuit optionally sends an alert to the remote monitoring service, which may then communicate with both internal and external personal computing devices, and with users via Short Message Service (SMS) messages, real-time notifications, or email. These devices may also notify other systems, thus allowing for a comprehensive notification service.

Updates from any of the trailer components including the security seal (or the adapter where the two are separate) may include location data gathered by location finding circuitry in the trailer components, or optionally in the master control circuit. Location finding systems may utilize any suitable location finding technologies, either alone or in concert, including the Global Positioning System (GPS), the GLObalnaya NAvigatsionnaya Sputnikovaya Sistema or Global Navigation Satellite System (GLONASS), mobile signal tracking, Wi-Fi, and/or Bluetooth, to name a few nonlimiting examples. The remote monitoring service optionally receives these updates and the location data, and may be configured to store this information in an event log in a data store. The data store optionally includes boundary data and triggering rules, allowing the system to define safe zones where alerts are suppressed, as well as rules for triggering when alerts should be sent, and to whom, or to what systems. The system can determine if a security event occurred inside or outside predefined geographical areas, using triggering rules to determine the appropriate alert response.

In another aspect, the cable of the security seal may include connection terminals, which are arranged and configured to connect to the adapter's analog input connectors, or to a connector of the security seal where seal, cable, and adapter are mounted to a common housing. A retention mechanism in the connection terminals may be included to ensure a secure connection between the cable and the adapter. The adapter or security seal optionally includes a third connector with power, ground, and communication terminals, allowing it to connect to the trailer wiring system. The control circuit of the adapter/security seal optionally monitors the cable's continuity, while the memory optionally stores a unique identifier for the seal.

The security cable may be electrically conductive, resistive, or both, with a resistor sometimes included separately or integrated into the cable itself. The cable may comprise conductive strands or fibers, potentially including non-conductive strands for added strength or protection for the conductive strands. These strands may have differing cross-sectional areas. A protective layer, such as a sheath or coating, optionally protects the cable from damage and tampering. This layer can be made of polymeric materials, metal, Fiberglass®, or other materials like Kevlar®.

In another aspect, the nosebox of the trailer optionally houses the master control circuit, and the master control circuit may be configured to electrically connect to the towing vehicle's power and ground terminals. The master control circuit may receive control input from the towing vehicle and send control commands to the different trailer components. These components, in turn, may be configured to send operational status and component data back to the master control circuit via a data bus.

The trailer wiring system optionally includes this data bus, comprising communication cables, a power cable, and a ground cable. The security seal and other trailer components may connect to this system via a single connector, or via the adapter of the present disclosure. A slave control circuit, located either within the security seal/adapter or a separate connector, optionally includes power and ground connections to individual trailer components. This slave control circuit may include a unique address and may be configured to operate in specific modes. Communication between the master and slave control circuits may be provided for by any suitable communication protocol, such as the CAN or LIN protocol.

In another aspect, the trailer wiring system may include a cable assembly with dedicated power and communication cables. A voltage transformer may be included to boost the voltage within the system, allowing smaller gauge wires to be used to thereby reduce electrical losses and reduce the overall quantity of metal in the wiring system without compromising performance. The master control circuit may include a microcontroller, voltage regulator, and transceiver, while the slave control circuit optionally includes its own separate microcontroller, voltage regulator, transceiver, switching device, and control logic.

Further forms, objects, features, aspects, benefits, advantages, and examples of the present invention will become apparent from the claims, detailed description, and drawings provided herewith.

### BRIEF DESCRIPTION OF THE DRAWINGS

FIG. 1 is a component diagram illustrating an example of components that may be included in a security system of the present disclosure.

FIG. 2 is a component diagram art illustrating examples of components that may be included in a security seal and adapter of the present disclosure.

FIG. 3 is a component diagram illustrating additional aspects of a security system of the present disclosure.

FIG. 4 is a diagram illustrating examples of geographical regions that may be used by the security system of the present disclosure.

FIG. 5 is a component diagram illustrating additional aspects of a security seal and/or adapter of the present disclosure.

FIG. 6 is a component diagram illustrating another example of a security seal of the present disclosure.

FIG. 7 is a component diagram illustrating optional aspects of a security cable of the present disclosure.

FIG. 8 is a diagram illustrating an example of a securities seal and/or adapter in use with a lock mechanism according to the present disclosure.

FIG. 9 is a component diagram illustrating aspects of a trailer wiring system that may be used in conjunction with the security system of the present disclosure.

FIG. 10 is a component diagram illustrating aspects of a trailer wiring system that may be used in conjunction with a security system of the present disclosure.

FIG. 11 is a component diagram illustrating aspects of a trailer wiring system that may be used in conjunction with a security system of the present disclosure.

FIG. 12 is a component diagram illustrating aspects of a trailer wiring system that may be used in conjunction with a security system of the present disclosure.

FIG. 13 is a component diagram illustrating aspects of a master control circuit that may be used in conjunction with a security system of the present disclosure.

FIG. 14 is a component diagram illustrating aspects of a slave control circuit that may be used in conjunction with a security system of the present disclosure.

### DETAILED DESCRIPTION

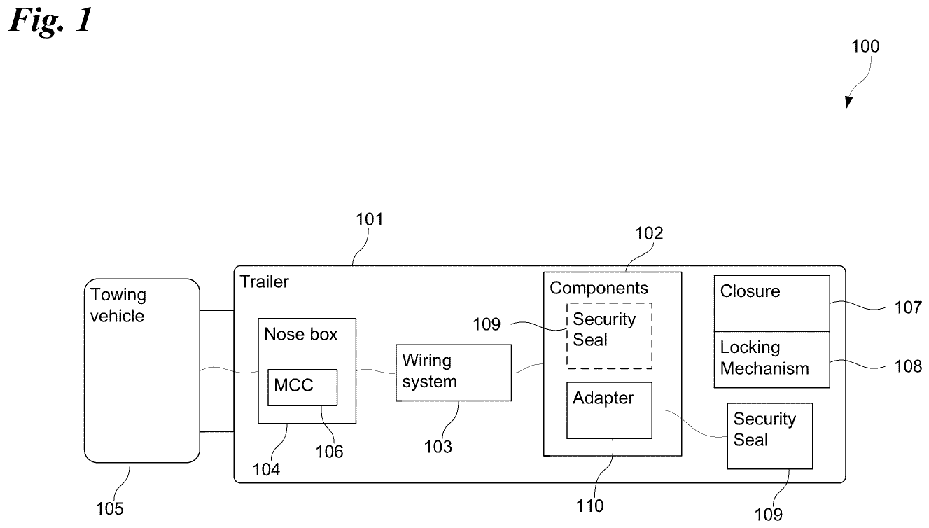

Illustrated at 100 in FIG. 1 is one example of a trailer security system that optionally includes a security seal of the present disclosure. The trailer security system as disclosed herein may be used in any type of vehicle such as a bus, trailer, ship, barge, aircraft, or other vehicle carrying cargo. The present security system may be used on the trailer itself, or with individual items, containers, boxes, or other objects where it may be useful to be alerted if the object is tampered with.

A trailer 101 as illustrated in FIG. 1 optionally includes trailer components 102, one of which may be an adapter 110 that is electrically connected to a security seal 109. In some instances discussed herein elsewhere, the security seal may be one of the trailer components and may not require an adapter. A trailer wiring system 103 electrically connects the trailer components to a master control circuit 106. The trailer may also include a closure 107, and a lock mechanism 108 (also referred to herein as a locking assembly) operable to secure the closure and to indicate that the closure is not to be accessed or tampered with by unauthorized individuals. The term “closure” as used herein generally means a door, gate, cable, strap, or other item or assembly, useful for retaining and keeping an item, or collection of items, contained, and place, enclosed, or protected. The trailer is optionally coupled to and towed by a towing vehicle 105, and may serve as a towing vehicle for other trailers optionally coupled to trailer 101.

The trailer components may be mounted to the trailer either within the interior of the trailer, on the outside of the trailer, or any combination thereof. The trailer components optionally include stop/turn/tail lamps, clearance lamps, backup cameras, Anti-Lock Brake System (ABS) controllers, tire pressure sensors, cargo sensors, motion sensors, proximity sensors, and the like.

The trailer wiring system optionally carries signals and power to various subsystems of the vehicle including the trailer components. The trailer wiring system optionally electrically connects trailer components with each other as well as to the trailer wiring itself. In one aspect, the trailer wiring system optionally electrically connects the trailer components with a nosebox 104 of the trailer, and optionally with the master control circuit. The trailer wiring system may include electrical connections to the towing vehicle, and possibly to a second, third, or subsequent trailer coupled to the present trailer 101. The towing vehicle may include logical, physical, and/or electrical connections with the nosebox, or wireless connections with the master control circuit or other aspects of the trailer.

As disclosed herein, the master control circuit may be in communication with any of the different examples of a security seal of the present disclosure. As noted above, the master control circuit is optionally generally in communication with multiple trailer components via the trailer wiring system. For example, the master control circuit is optionally operable to determine component outages, to collect status information about trailer components, and to periodically relay this information to remote servers via communication links of the present disclosure. The master control circuit is optionally operable to communicate with remote services or systems, with the vehicle towing the trailer (if there is one), and to manage power provided to the trailer components, as well as a flow of data between the trailer components and the master control circuit.

The master control circuit is optionally configured to generate a security update and to send it to a remote monitoring service of the present disclosure. In another aspect, the master control circuit may be configured to establish and/or maintain one or more communication links with a remote monitoring service of the present disclosure. In another aspect, the master control circuit may be configured to accept the status updates from trailer components, particularly a security seal of present disclosure.

The master control circuit may, for example, be configured to send an alert to the remote monitoring system when the electrical continuity of the security cable is broken. This may optionally occur when the security cable is broken by authorized personnel after delivery is made. This therefore may be a useful way to indicate successful delivery of the object the security seal is coupled to.

In another aspect, the master control circuit may be configured to send an alert to the remote monitoring system when the security cable is tampered with or removed by an unauthorized party, such as while attempting to gain access to the contents of the trailer without permission.

In another aspect, the master control circuit may be configured to send an alert to the remote monitoring system when the electrical connection between the adapter that a security seal is coupled to, and the master control circuit is lost, or if the electrical connection between the master control circuit and the security seal itself is lost (in the case where there is no adapter). This may optionally occur when the connection between the master control circuit and the seal and/or the adapter is tampered with or damaged.

The lock mechanism optionally allows the closure to be selectively opened or closed. For example, where the closure is a door, like those that may be found on a trailer, the lock mechanism may be arranged and configured to allow the door to be selectively maintained in a secured (locked) state, or an unsecured (unlocked state).

The lock mechanism optionally includes openings through which a portion of a security device may pass. The lock mechanism may be arranged configured to prohibit entry through the closure when a lock or security seal is coupled to the lock mechanism, such as when a portion of the security device passes through at least a portion of the lock to maintain it in a locked state, or to provide visible notice that the lock mechanism is in the locked state.

The trailer components and master control circuit are optionally configured to communicate with each other using a digital communication protocol. The adapter may be arranged and configured to accept analog input from a security seal, and to convert that analog input to digital data signals, packets, and the like that are expected by the master control circuit. The trailer wiring system optionally includes and maintains a network for carrying data between nodes (i.e. any circuits or devices coupled to the network) using a suitable network protocol such as the CAN or LIN protocol. The master control circuit and some, if not all, of the trailer components optionally operate as nodes on this internal vehicle network.

The security seal of the present disclosure may be used in a wide array of scenarios where a system or interested party may be interested to know if tampering has occurred. For example, the security seal may be useful for alerting remote systems or relevant interested parties that the trailer, or some subsystem or other portion thereof, has been tampered with. In another example, the security seal may be useful for alerting remote systems or interested parties that some portion of the load has been tampered with such as an individual crate, pallet, shipping container, box, or loosely wrapped collection of items.

The security seal optionally includes an electrically conductive and/or an electrically resistive aspect such as a cable and a resistor connected in series. The adapter optionally provides an interface between the security seal and the trailer wiring system. The adapter may include a control circuit configured to monitor the security seal to determine when security seal has been broken, or tampered with. The adapter optionally includes inputs that the security seal is coupled to and/or electrically connected to, and the control circuit of the adapter may be configured to measure, calculate, or otherwise determine the electrical resistance of at least a portion of the security seal. The adapter control circuit is optionally configured to determine changes to the resistance of the security seal over time, and optionally to send data about the state of the security seal to the master control circuit. The master control circuit may then send this data on to a remote monitoring service, remote server, or personal computing device, or to the towing vehicle, to name a few nonlimiting examples.

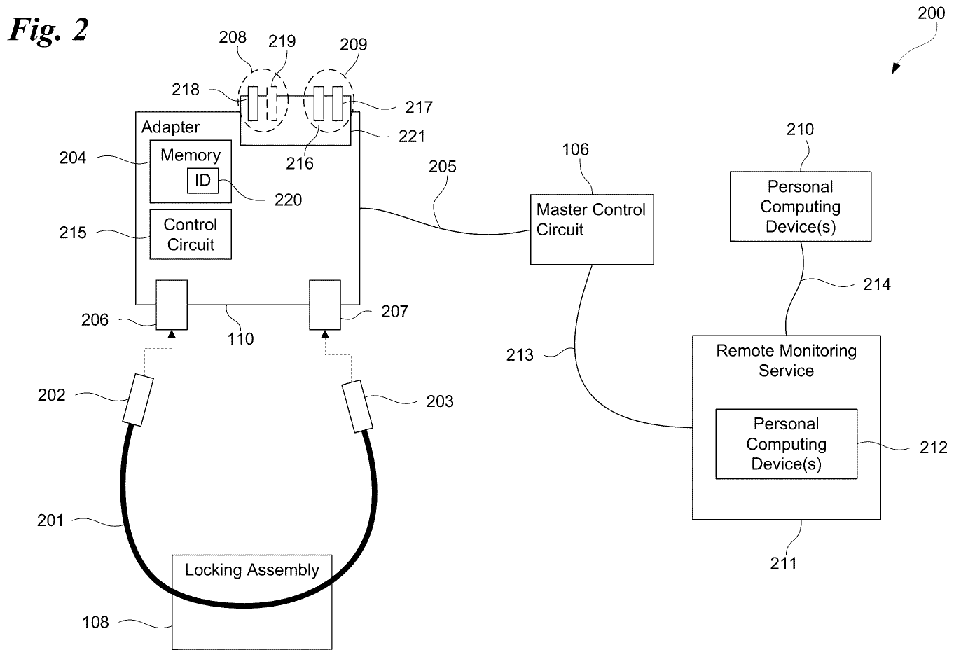

Illustrated at 200 in FIG. 2 are additional optional aspects of a trailer security system 200 of the present disclosure. The trailer security system 200 optionally includes a security seal of the present disclosure, that may be coupled to an adapter 110. Status information provided by the security seal (and/or the adapter) may be sent to a personal computing device 210, a remote monitoring service 211, or any combination thereof.

The security seal optionally includes a cable 201. The cable optionally includes a first connector 202 and a second connector 203. In one aspect, the cable may be electrically conductive. The connectors may be for electrically connecting the cable to the adapter, thus, in one example, effectively creating a security seal of the present disclosure.

In another aspect, the connectors may be insertable into a security seal of the present disclosure, which may be a separate item from the adapter and the cable. In another example, as discussed below, the cable may be fixed to the security seal at one end, and another portion (such as the opposing end of the cable) may be selectively insertable into the security seal. In another aspect, the connectors 202, 203 may be separate components from the cable, attachable to the cable such as by crimping, soldering, and the like, or these connectors may simply be the opposing ends of the bare cable which may be insertable into the security seal and/or the adapter.

In another aspect, the cable may be operable to pass through at least a portion of the locking assembly. The locking assembly may be arranged and configured to selectively hold a door or other closure of the trailer in a locked state.

The adapter optionally includes a memory 204, and is configured to maintain a communication link 205. A first input connector 206, a second input connector 207, and a data connector 208 are optionally included which may include a first data pin 218, and optionally one or more second data pins 219. A power connector 209 may be included which optionally includes a power pin 216 and a ground pin 217. In one aspect, the memory optionally stores an identifier 220 that identifies the adapter as being different than other adapters of other security seals.

In another aspect, the power connector may be arranged and configured to send or provide electrical power from the nosebox and/or the master control circuit to the adapter or seal. Similarly, the data connector may be arranged and configured and operable for sending data to a recipient that is remote from the adapter, such as a master control circuit in the nosebox, or optionally to a remote server. This may be achieved by first sending data to the master control circuit via data cables in the trailer wiring system.

In another aspect, the data pins and power and ground pins may be arranged and configured as separate connections, or together as a single connector 221 that may be physically, directly, electrically, or otherwise coupled to a corresponding connector of the trailer wiring system. This single connector configuration may be present in any adapter, security seal, or other trailer component of the present disclosure.

In one aspect, the cable of the security seal may be electrically connected between the first and second input connectors. For example, the security cable may be coupled to and mounted to the adapter such as by a solder connection between a connector (such as connector 202) and the first input connector 206. The second input connector 207 may, in this example, be for electrically connecting the security seal to the adapter by removably coupling connector 203 with the second input connector 207. In another aspect, the cable may be partially resistive having a known fixed resistance with a narrow deviation from a predetermined nominal value. The adapter may be operable to send an alert to a master control circuit when the electrical continuity of the security cable is substantially changed or broken.

The communication link may be included to optionally provide for communication between the adapter and a master control circuit of the present disclosure. In one aspect, the communication link may include the trailer wiring system. In another aspect, the communication link may include the use of a wireless communication protocol such as WiFi, Bluetooth, and the like.

The master control circuit is optionally operable to determine its geographical location and to include location data in any alerts sent to a remote monitoring service. In another aspect, the adapter optionally includes circuits that include location finding capabilities or devices that may be operable to determine the geographical location of the adapter. The adapter may include that location data in any status updates, or alerts, sent to a master control circuit, or to a remote monitoring service.

For example, the adapter may detect a change in the resistance of the first input connector relative to the second input connector, and this change may exceed a predetermined threshold stored in the memory of the adapter. In general, the resistance between these two input connectors should be very close to the resistance of the cable. In the case of a metallic cable, this resistance value should be near zero ohms, given the short length of the cable (perhaps less than three inches, less than a foot, or less than five feet). In this example, the adapter may send a notification of this change to the master control circuit, and optionally, it may include location information with this notification.

In another example, the adapter may send a continuous stream of data that includes the resistance level across the two input connectors. This data may be sent at predetermined intervals to the master control circuit irrespective of the levels of resistance that are detected. The master control circuit may include a memory, processor, control logic, and location finding circuitry, and it may be configured to accept the data sent by the adapter, or by several adapters coupled to security seals of the present disclosure. The master control circuit may compare the incoming data to predetermined resistance levels to determine if the security seal has been tampered with or broken (e.g. continuity across the cable has been broken). When the master control circuit determines that the security seal has been tampered with or broken, an alert may be sent to the remote monitoring service via a communication link 213.

The remote monitoring service optionally communicates with personal computing devices 212, which may be part of the remote monitoring service. In another aspect, the remote monitoring service optionally communicates with other personal computing devices 210 which are not part of the monitoring service via a communication link 214. The remote monitoring service may be configured to accept status updates, alerts, location data, and any other data sent from any master control circuit, security seal, or adapter of the present disclosure that may be configured to send such data.

The remote monitoring service may be in communication with personal computing devices, or may include personal computing devices as part of the remoting monitoring service. The personal computing devices may be operable to receive status updates, alerts, and any other data provided by the remote monitoring service. In one aspect, the personal computing devices may be configured to notify users directly, such as via an SMS text message, by a real time notification appearing on a smart phone screen, via an email message, or by any other suitable means.

In another aspect, the personal computing devices may be configured to notify other systems configured to accept input from the remote monitoring service and to act accordingly. In another aspect, the personal computing devices may be configured to provide security input to other monitoring services which may themselves be configured to notify other users.

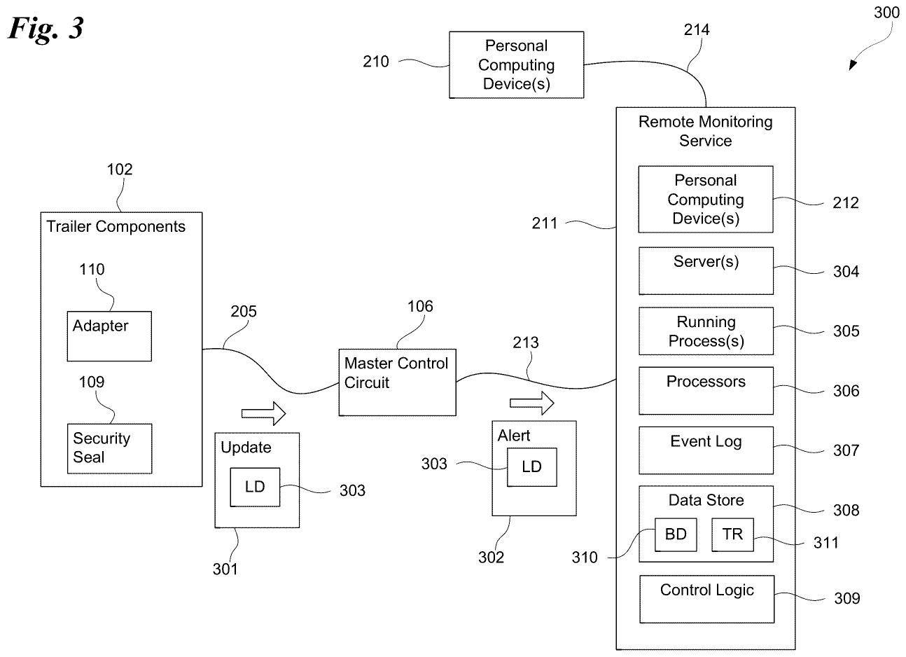

Illustrated at 300 in FIG. 3 are additional optional aspects of a trailer security system of the present disclosure. As discussed herein elsewhere, the trailer components communicate with a master control circuit via the communication link. These trailer components optionally include an adapter of the present disclosure, and/or a security seal, as well as other types of components discussed above. The master control circuit optionally communicates with a remote monitoring service, which in turn may be in communication with various personal computing devices.

An update 301 may be created and sent from a trailer component such as an adapter, a security seal, or both, or from another different trailer component operable to send such updates. These updates may include location data 303 that defines the physical location of the trailer component on the surface of the earth. The update may be a status update or security update indicating the state of the security seal. The update is optionally sent when the state of the seal changes, preferably as soon as possible thereafter.

The update is optionally sent by the control circuit in the adapter coupled to the seal, or from the security seal itself, if these components include communication circuitry and control circuitry arranged and configured to send such an update. The update may be configured as an alert 302 by the adapter or seal, such as in the case of a security alert indicating the seal has been breached. In another aspect, the alert may be generated by the master control circuit using information in the status update. In either case, the update may include a status alert when the status of the security seal changes. Thus, an alert or status update of the present disclosure may be sent from the security seal, from the adapter the security seal is attached to, or from the master control circuit in the trailer. The alert may be subsequently sent by the remote monitoring service to another computing device unaltered, or the alert received from the master control circuit may be reformatted into a different type of message by the remote monitoring service before it is broadcast to other computers. Varying notification message types include, but are not limited to, emails, SMS messages, notifications, and the like.

As noted above, the location data is optionally sent to the remote monitoring service by the master control circuit, the security seal, or the adapter, or any combination thereof. The location data in the update or alert optionally defines a location for the security seal, the adapter, the master control circuit, the trailer, or any combination thereof, preferably anywhere on the surface of the earth.

In another aspect, any suitable location finding system, service, technology, or process is optionally used to determine the location. In another aspect, GPS may be used. In another example, GLONASS may be used. Also, mobile signal tracking and/or triangulation from cell towers, Wi-Fi, Bluetooth, or any combination of these, or of any other location finding technology, may be used.

The remote monitoring service is optionally configured to accept status updates from any master control circuit, security seal, or adapter of the present disclosure that may be configured to send such updates. These status updates may be sent to a personal computing device when the security update indicates the security seal has been broken. The status updates may also be sent at predetermined intervals according to a schedule stored in the master control circuit. For example, the interval between updates for one or more trailer components sent by the master control circuit may be less than a second, less than 5 seconds, less than 30 seconds, less than 10 minutes, or at an interval of every 10 minutes or more.

The remote monitoring service is optionally configured to receive location data defining a geographical location of either the master control circuit, the security seal, the adapter, or any combination thereof. The remote monitoring service optionally includes one or more servers 304, one or more processors 306 executing one or more running processes 305, an event log 307, a data store 308, and control logic 309.

In one aspect, the one or more processors are optionally executing at least at least one running process. The running processes optionally include instructions that configure a monitoring service to operate according to the present disclosure. The event log is optionally configured to capture and store information about the status updates received from trailer components. In another aspect, the event log is optionally configured to capture and maintain information about the geographical location of trailers and trailer components.

In another aspect, the data store is optionally configured to store boundary data 310 defining one or more geographical regions. The data store is optionally configured to store triggering rules 311 indicating different types of alerts that are to be sent for corresponding types of events occurring relative to different geographical regions defined by the boundary data.

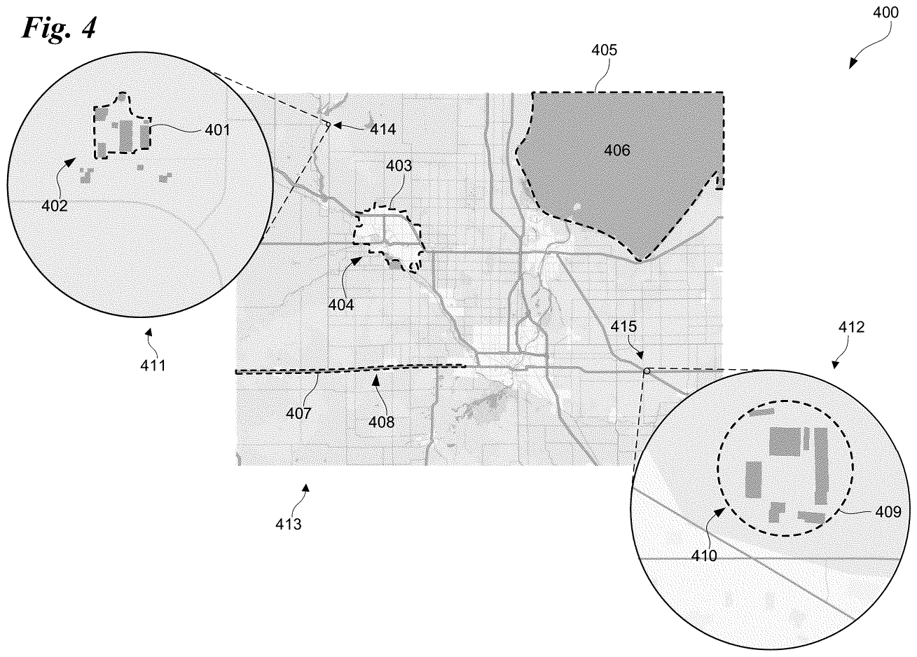

Illustrated at 400 in FIG. 4 are examples of one or more geographical areas defined by boundary data. For the purposes of illustration, a region 413 is shown which optionally corresponds to a physical location on the earth, and two smaller regions shown at 414 and 415 are enlarged at 411 and 412 respectively to illustrate additional detail.

In one example, a geographical area 401 may be defined by an irregularly shaped polygon that approximates the area immediately surrounding one or more buildings at 402, while excluding others. In another example, a geographical area 403 may be defined by a polygon that approximates the boundaries of a municipality, state, province, county, or other political boundary at 404. In another example, a geographical area 405 of the present disclosure may be defined by a polygon that approximates one or more geographical features such as a mountain, river, canyon, prairie, or a body of water such as the body of water at 406. The boundary may include the entire geographical feature, or any portion thereof, and may defined by other natural features such as a shoreline, cliff, mountain, valley, and the like.

In another example, a geographical area 407 of the present disclosure may be defined by a polygon that approximates a path, road, railroad, trail, highway, freeway, or other private or public throughway for accommodating travel such as the one shown at 408. The boundary data may define a portion of the throughway such as a single lane, multiple lanes, some or all lanes for a predetermined distance, and the like. In another example, a geographical area 409 may be defined by a regularly shaped polygon such as a circle, that defines an area within which a number of buildings or other objects or structures may be positioned at 410. In this example, the circle at 410 may also be thought of as a geographical area having a center point with a predetermined radius thus defining an area based on a central location in a maximum distance away from the central location. Other regular polygons such as squares, rectangles, hexagons, octagon's, and the like, may be useful as well for defining a geographical area.

In one aspect, some geographical regions may be considered “safe” zones. Examples of these might be regions 401 and 409. In another aspect, status updates indicating that the security seal has been broken may optionally refrain from triggering an alert or warning when the updates originate from a security seal or other trailer component that is in a safe zone. This may optionally occur, for example, when a seal is being broken and then replaced multiple times while a trailer or container is being loaded within an area that is considered “safe”, or “secure”. In another aspect, status updates that do not result in an alert or warning being sent may be also logged in the event log anyway for archival purposes.

The control logic optionally executed by one or more processors of one or more computers of the remote monitoring service is optionally configured to use the triggering rules and the boundary data to determine when the master control circuit, the security seal, or the adapter control circuit are inside or outside at least one of the one or more optionally predefined geographical areas according to the location data. For example, the control logic may compare location data with the boundary data stored in the data stored to determine if the location received is inside or outside of a predetermined geographical region. The triggering rules and other criteria may then be applied by the processors of one or more computers of the remote monitoring service to determine what type of alert to trigger, how important, severe, or critical the alert is, and to whom it should be sent, to name a few nonlimiting examples of the triggering criteria.

In another aspect, the control logic of the remote monitoring service is optionally configured to refrain from sending a security alert to one or more other computing devices when the seal has been broken inside at least one or more geographical areas. In another aspect, the control logic may be configured to send an alert when a status update is received indicating that the security seal has been broken, and the accompanying location data obtained with the status update indicates that the event occurred outside of any predetermined geographical region. In another aspect, the triggering rules may define that the security system of the present disclosure must always send an alert when a security seal has been broken or tampered with inside certain “unsafe” zones or areas specifically configured to require sending an alert according to the boundary data.

The communication links between the remote monitoring service and the personal computing devices are established and maintained either by the remote monitoring service, by the personal computing devices, or by any combination thereof. The personal computing devices are optionally configured receive an alert sent from the master control circuit or directly from a trailer component, and to send a corresponding security notification to one or more other computing devices. In another aspect, examples of other computing devices optionally include, but are not limited to smart phones, laptop computers, tablet computers, other servers or server farms, and the like.

The geographical regions maintained by the remote monitoring service may in some instances be defined according to a predetermined route. Thus, one region, such as region 409 may be at least temporarily marked or tagged as a “start” region, while region 401 may be tagged or marked in the remote monitoring service as an “end” region. As illustrated in FIG. 4, the start and/or end regions may include, or may optionally be defined according to, a location, such as a lot, warehouse, terminal, port or other area where shipments are marshaled before transportation begins, or are received after the transportation is completed. In another aspect, the start or end may be the place where a trailer is loaded and stored temporarily before being coupled to a truck. In another aspect, movements within the zone may be considered inconsequential with respect to reporting changes in the status of the security seal of trailers or items secured there with.

In another aspect, the end region may be defined as a safe or secure zone. In another aspect, the security service may be configured to refrain from sending a security alert to one or more other computing devices when the seal has been broken inside the ending region. In another aspect, the service may be configured to suppress security alerts sent by the security device when the security device, the master control circuit, and/or the adapter is in the predefined geographical zone. In another aspect, a security seal or adapter of the present disclosure may optionally include location finding and suppression logic thus configuring the adapter and/or the security seal to refrain from sending status updates when the seal is within a predetermined geographical area.

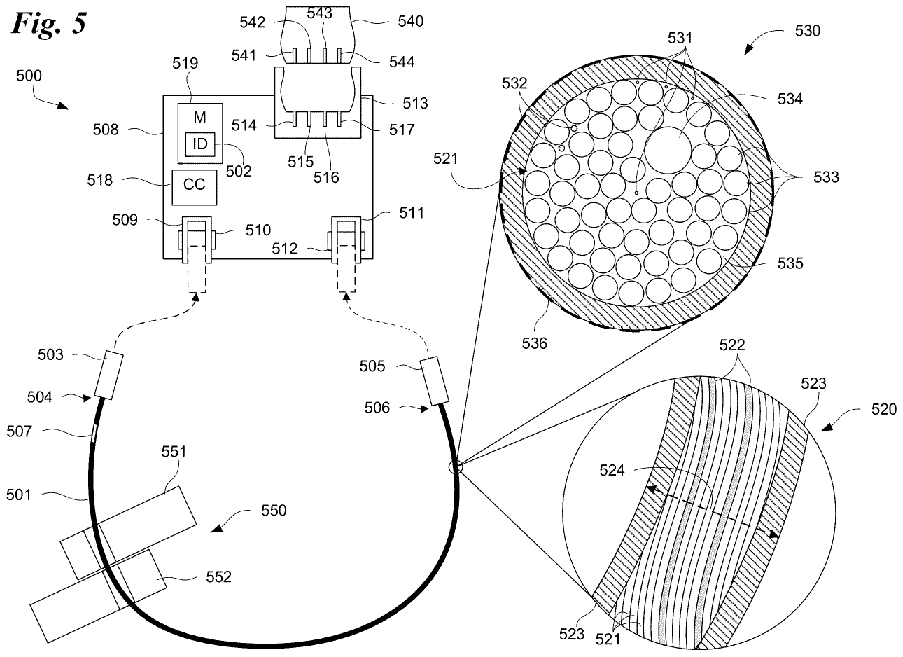

Illustrated at 500 in FIG. 5 is another example of a security seal illustrating other aspects that may be included in any of the security seals of the present disclosure. An exemplary security cable 501 and adapter 508 according to the present disclosure are shown. The adapter optionally includes a first analog input connector 509, a second analog input connector 511, and a third connector 513. The security cable optionally includes a first connection terminal 503, and a second connection terminal 505 that is configured to electrically and physically connect to the analog input terminals 509 and 511 of the adapter.

The first connection terminal optionally includes a first end 504, and a second connection terminal optionally includes a second and end 506 of the cable, the first and second ends may be opposing ends of the cable. One or the other, or both, ends of the cable may alone be operable as a connection terminal (i.e. coupling the security cable to the adapter may be as simple as inserting opposing ends of the cable into the first and second analog input connectors).

The ends of the cables, and/or the connection terminals, are optionally selectively matable and unmatable with the first and second analog input connectors. As shown in FIG. 5, the connectors 503, 505 are optionally movable from an unmated position, to a mated position (dotted lines) where, in this example, the connectors are inserted into the first and second analog input connectors.

In one aspect, the first connection terminal is optionally mounted adjacent to or at a first end of the security cable, and the second connection terminal is optionally mounted adjacent to or at a second end of the security cable that is different from the first end. In another aspect, the first and second connectors are optionally mounted at or adjacent opposing ends of the cable.

The first and second analog input connectors optionally include retention mechanisms 510, 512 respectively. These retention mechanisms are optionally arranged and configured to retain the first and second connection terminals adjacent to the first and second analog input connectors respectively. The retention mechanisms of the present disclosure may use any suitable technique to maintain the connection terminals of the cable in electrical and/or physical connection with the analog input connectors of the adapter. These include, but are not limited to, friction fit, press fit, interference fit, threaded screws, nuts, bolts, pins, springs or other biasing elements, and the like.

In one aspect, the first and second analog input connectors optionally define cavities arranged and configured to receive the first and second connection terminals of the security cable, which may include, or be limited to, the opposing ends of the security cable. In another aspect, the first and second connectors are optionally arranged and configured to be insertable into the first and second input connectors of the adapter as shown by the dotted lines in FIG. 5.

The third connector optionally has at least four terminals that optionally include a power terminal 514, a ground terminal 515, a communication terminal 516, and a communication terminal 517. In another aspect, the power, ground or communication terminals may be arranged and configured to operate as receptacles accepting corresponding power 541, ground 542, and communication pins 543, 544 of a connector 540 of the trailer. In another aspect, the power, ground or communication terminals may be arranged and configured to operate as projecting members accepted by corresponding power, ground, and communication terminals of the connector of the trailer.

According to the example shown, it may be inferred that the trailer connector 540 is insertable into the connector 513. This is merely one possible configuration. Any suitable configuration may be used such as where the trailer connector is configured to receive the third connector of the adapter, or, a portion of the trailer connector receives a portion of the third connector, while a separate portion of the trailer connector is received by the third connector.

The adapter optionally includes a control circuit 518. The control circuit is optionally electrically connected to the terminals of the first and second analog input terminals, and to the third connector. The control circuit is optionally operable to monitor the electrical continuity of the security cable that is electrically connected to the first and second input terminals. Monitoring or determining the electrical continuity optionally includes determining the combined resistance of the cable and the resistor (which, as discussed herein elsewhere, may be a separate resistor, or an intrinsic resistive property of the cable).

The adapter optionally includes a memory 519. The memory optionally stores an identifier 502 that distinguishes the adapter from other adapters of other security seals. The third connector is optionally configured to use the terminals of the third connector to send signals reporting the electrical continuity between the first and second input terminals. In another aspect, the third connector is optionally configured to use the terminals of the third connector to send a security alert when the electrical continuity is broken between the first and second input terminals.

As with other security cables discussed herein elsewhere, a security cable is optionally electrically conductive, electrically resistive, or any combination thereof. An exemplary resistor 507 may be included separately from, along with, or as part of, the cable 501. In one aspect, the resistor 507 may be an intrinsic or added property of the security cable. In one aspect, the security cable optionally comprises resistive fibers that give the cable a predetermined known resistance that is different and higher than the resistance of the cable without the resistive fibers.

In another aspect, the resistance of the cable may be adjusted by the addition of a physical resistor electrically connected in series to the cable such that breaking the cable causes a change in the resistance from a nominal known value to a different value that is higher or lower than the nominal value. The resistor is optionally electrically connected in series with the cable between the first and second terminals. In another aspect, determining electrical continuity optionally includes determining the combined resistance of the cable and the resistor.

A higher value may be understood by the control circuit as an input signal indicating a break in the cable, such as when the cable is damaged, broken, or intentionally cut to gain unauthorized access. In that example, the resistance may be detected by the control circuit to change from a value close to the expected nominal value (i.e. within 1%) to a value that is thousands or millions of times larger, or is infinitely high (i.e. so high the control circuit cannot measure it).

Preferably the resistance of the security cable has close tolerances and varies from a predetermined value by values such as less than plus or minus 0.1% of the predetermined value, by less than plus or minus 1% of the predetermined value, by less than plus or minus 5% of the predetermined value, or by less than plus or minus 10% of the predetermined value, or by less than plus or minus 20% of the predetermined value.

The security cable optionally comprises primarily electrically conductive materials such as metal fibers, cords, cables, strands, or other conductive elements. Examples of such strands or fibers 521 are illustrated with additional detail at 520. In another aspect, the security cable may include optionally electrically resistive wire with a predetermined resistance that may be monitored by the security seal or adapter control circuit.

The security cable optionally includes one or more conductive stands or fibers 522 in the cable. The conductive strands may comprise some of the fibers or strands included in the security cable. For example, the security cable may comprise one conductive wire, or strand, within a bundle of strands wound together to form at least a portion of the security cable, if not the entire cable. In another example, the security cable may comprise two or more conductive wires, or strands, within a group of strands wound together to form at least a portion of the security cable. In another aspect, all of the strands of the security cable may be conductive with a collective nominal resistance that is less than 1 ohm.

In another aspect, some of the strands within the security cable are conductive, while others are not conductive. The nonconductive (insulative) strands may comprise primarily electrically nonconductive materials such as polymeric or cellulose-based insulative compounds, Fiberglass®, Kevlar®, or other generally resistive or insulative fibers which may be included for strength or other properties, but not for the purpose of conducting electricity.

Some of the wires, strands, or other materials included in the security cable may be of differing sizes. Examples of varying cross-sectional areas for the conductive, insulative, or other strands or wires that may be corporative into a security cable of the present disclosure are illustrated in the enlarged cross-sectional view at 530. The sizes of the strands 521 are illustrated with differing cross-sectional areas. For example, many of the strands 533 may be of the same, or substantially the same, cross-sectional area. Some strands or fibers 531 may be substantially smaller defining a cross-sectional area that is less than 2% of the cross-sectional area of the strands 533. In another example, the fibers, strands, or wires, 532 are smaller than those at 533 having a cross-sectional area that is about 5% of the cross-sectional area of the strands 533. In another aspect, some of the strands 521 may be larger than others. For example, a single-strand 534 may be included that is over 2 times larger in cross-sectional area then some of the other strands 533, or over 26 times larger in cross-sectional area than strands 531. Any suitable combination of sizes of strands may be incorporated, any of which may be electrically insulative, electrically conductive, electrically resistive, or may incorporate aspects of any combination of these three properties.

The strands or fibers in the security cable may incorporate electrically insulative materials into strands which have a significantly larger cross-sectional area than the electrically conductive strands or other materials included in the security cable. For example, the electrically conductive (and/or any electrically resistive) strands may define a cross-sectional area that is less than 1% of the cross-sectional area of the smallest of the nonconductive strands, or optionally less than 35% of the cross-sectional area of the smallest of the nonconductive strands, or only 1% less than the cross-sectional area of the smallest of the nonconductive strands. In another aspect, the conductive strands may define a cross-sectional area that is about the same as the nonconductive strands, or possibly larger; or optionally 1% larger than the smallest of the nonconductive strands.

Varying the sizes, strength properties, electrical properties, and/or materials used in the electrically conductive, electrically resistive, electrically insulative, or other elements of the security cable may be advantageous to reduce or eliminate the possibility of tampering with the cable without cutting the resistive or conductive strands or wires in the cable. For example, if the security cable incorporates nonconductive cables of large-size (e.g. strands 534) with a very small electrically conductive or electrically resistive cable (e.g. 531) that is difficult to manipulate without breaking, then nearly any attempt to force the security cable from its position in a lock mechanism (a portion of which is shown at 550) would likely result in a loss of continuity between the two ends of the security cable, thus allowing the system of the present disclosure to report that the locking device have been tampered with. In another aspect, smaller conductive or resistive strands (e.g. 532) may be physically wrapped around other strands (e.g. 533) in the cable which may be electrically disconnected therefrom, thus further complicating the possibility of breaking the larger strands without breaking the smaller conductive resistive strands.

For example, most of the wires or strands in the security cable may be 20 gauge wires according to the American Wire Guage (AWG) standard, while other strands in the security cable may be 30 gauge wires, thus defining a cross-sectional area for the smaller strands that is about one third the size of the others. In another example, all but one of the strands in the disclosed security cable may be 16 gauge strands defining a cross-sectional area of about 1.31 mm², while the one remaining strand may be a 29 gauge strand defining a cross-sectional area of about 0.0642 mm². In this instance, the single-strand is less than 5% of the cross-sectional area of the larger strands.

The security cable optionally includes a protective layer 523, some additional details of which are illustrated in the enlarged cross-sectional view at 520. The protective layer optionally covers at least a portion of the strands that may be included in the security cable as shown at 520. The protective layer may be a sheath, coating, or other covering that optionally includes one or more different materials incorporated into the protective layer. These materials optionally include any suitable protective material such as polymeric materials, strands, or fibers, metallic sheets, strands or fibers, Fiberglass®, Kevlar®, UV reflective or absorbing coatings or materials, or any combination of these, or of other compounds useful for protecting the security cable.

The protective layer optionally substantially coats the security cable to reduce or eliminate stray interference that may result from touching the metallic portions of the security cable to other nearby metallic objects such as opposing portions 551 and 552 of the lock mechanism. The protective layer is also optionally operable to reduce or eliminate the opportunity for tampering with the security cable.

In another aspect, a security cable of the present disclosure may define a width 524 (with or without a protective layer) that defines a cross sectional area 536. The defined width may include the protective layer, or may be defined separately therefrom. In one example, the electrically conductive or electrically resistive strands account for greater than 90% of the cross-sectional area of the security cable, optionally greater than 75% of the cross-sectional area, optionally greater than 25% of the cross-sectional area, or optionally greater than 5% of the cross-sectional area. In some instances, the resistive or conductive strands may account for 5% of the cross-sectional area, or less.

In one specific example, the width of the security cable may be about 0.29 inches, with a protective layer incorporating a polymeric sheath around the cable that is 0.02 inches in thickness thus leaving 0.25 inches of the security cable for the strands or fibers within the sheath. The security cable may include 24 16 gauge steel cables and one 30 gauge electrically conductive or resistive cable. The 16 gauge steel cables in this example are optionally electrically insulated from the 30 gauge electrically conductive or resistive cable thus allowing the continuity determinations to be made accurately according to the resistance of the 30 gauge cable. Any suitable configuration of cabling may be included in any of the examples, thus allowing for a variety of different security cables to be used with a system of the present disclosure according to their respective intended purposes.

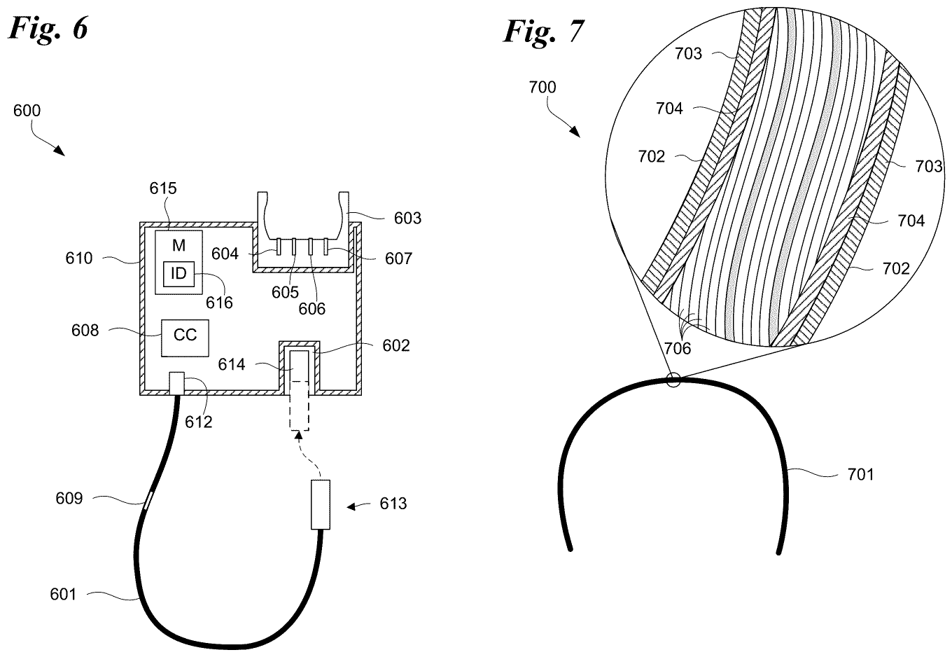

Illustrated at 600 in FIG. 6 is another example of a security seal of the present disclosure. A security seal of the present disclosure optionally includes an electrically conductive security cable 601, an analog input terminal 602, a trailer wiring connector 603, a control circuit 608, a resistor 609, and a housing 610. A memory 615 is optionally included that is configured to retain an identifier 616 that may be operable to uniquely identify one security seal of the present disclosure from another. The analog input terminal is optionally arranged and configured to receive one end of the security cable, and may be configured to pass through a portion of the housing as shown by the dotted lines in FIG. 6.

The trailer wiring connector optionally includes a power pin 604, a ground pin 605, a communication pin 606, and a communication pin 607. The control circuit is optionally electrically connected to the at least four terminals of the trailer wiring connector, the security cable, and the analog input terminal.

As disclosed herein in other examples of an adapter or security seal, the control circuit 608 is optionally operable to detect changes in the electrical resistance of the security cable. The control circuit may be operable to detect changes in electrical resistance between the analog input terminal and a different location of the security cable. In another aspect, this can optionally be adjacent to the opposing end, or any point along the cable. The resistor is optionally electrically connected in series with the cable, or is embodied in the cable as a resistive property thereof. Thus, the “resistor” may be the cable itself with resistive properties, strands, fibers, and the like. In another aspect, the control circuit optionally monitors the electrical resistance of the combination of the security cable and the resistor (or of the cable alone where the resistor is incorporated in the cable).

The housing optionally contains the control circuit and may be an anchor point for one end of the cable in a cable mount 612. A second opposing end of the security cable at 613 is optionally selectively insertable into the analog input terminal. The analog input terminal optionally defines a cavity 614 arranged and configured to receive the free end of the security cable 613.

Illustrated at 700 in FIG. 7 is another example of a security cable illustrating other aspects of the present disclosure. A security cable 701 of the present disclosure is shown which may include any of the properties disclosed herein relating to the resistive, conductive, or insulative nature of the cable, or to any security seal connectors or adapters that the cable may be electrically and/or physically connected to. The security cable optionally includes a protective layer 702. The protective layer optionally covers at least a portion of the conductive, resistive, or insulative strands, wires, cables, or fibers 706 that are within the security cable.

The protective layer may be a sheath, coating, or other covering that includes polymeric materials, strands, or fibers, metallic sheets, strands or fibers, or any combination thereof. The protective layer may optionally include multiple constituent layers. The protective layer optionally includes a first layer 703 and a separate second layer 704. The first layer may be conductive, resistive, or insulative such as in the case of a polymeric material that is reinforced with metallic fibers. The first layer may be for added strength or protection. The second layer is optionally insulative to avoid affecting the resistance of the conductive or resistive strands of the security cable. The second layer optionally includes more than one kind of polymeric material such as in the case of a layer or coating of one polymeric material that incorporates fibers, strands, or sheets of another polymeric material.

In another aspect, the security cable itself may be fully or partially contained within the second layer and may be electrically insulated from the first layer, which may be metallic. The protective layer optionally substantially coats the security cable to reduce or eliminate stray interference that may result from touching the metallic portions of the security cable to other metal objects nearby (such as may be found in the lock mechanism, trailer, container or other metal object that the security cable may be coupled to).

The protective layer may be relatively thick, while the electrically conductive or resistive portions of the security cable may be relatively thin thus optionally making it difficult to expose or tamper with the conductive portions of the security cable without causing a break in the continuity of the cable. For example, the strands or fibers of the internal cable may be less than 5% of the total combine thickness of the security cable and protective layer(s). In another aspect, the internal strands or fibers may be less than 1% of the total thickness of the combined strands and protective layer(s). In another aspect, the cable strands or wires inside the protective layer(s) may be 1% or more of the total thickness, 25% or more of the total thickness, 90% or more of the total thickness, or over 99% of the total thickness (meaning that the protective layers may be so thin as to be nearly undetectable).

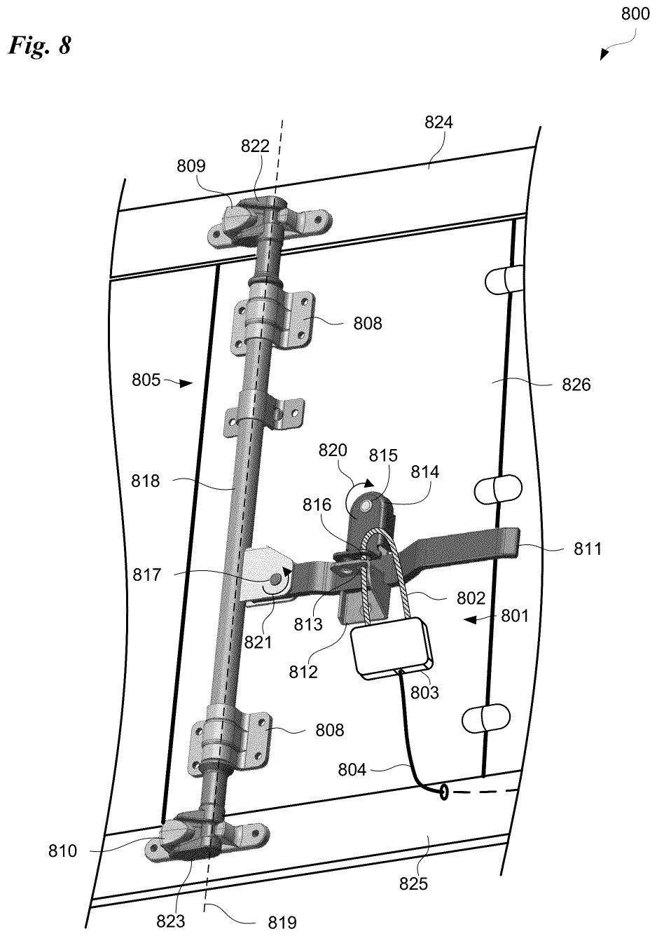

Illustrated at 800 in FIG. 8 is an example of a security seal of the present disclosure used in conjunction with a lock assembly of a truck trailer, shipping container, or other enclosure 824, a portion of which is illustrated along with a locking assembly 805. A security seal according to the present disclosure is shown at 801, the security seal optionally including a security cable 802, and an optional adapter 803. As discussed herein elsewhere, the adapter and cable may be two separate items where both ends of the cable are selectively coupled or uncoupled from the adapter portion of the security seal, or they may be configured as one item where one end of the cable is permanently coupled to the adapter, and a second end of the cable is selectively coupled or uncoupled from the adapter portion of the security seal. A power and/or communication cable 804 optionally couples the security seal electrically, and/or physically to the trailer wiring system allowing the security seal to report its status as discussed herein elsewhere.

FIG. 8 illustrates an example of a lock assembly such as may be used on a side or rear door 826 of a trailer, shipping container, or other enclosure. Relevant portions of the lock assembly and the security seal are not drawn to scale for clarity. The lock assembly may optionally include mounting brackets or hinges 808, upper and lower catches 809, 810 respectively, arranged and configured to engage upper and lower lugs 822, 823 respectively, and a rotating handle 811. Any combination of these or other parts may be included in the locking assembly mechanism. The brackets 808 are optionally mounted to the door, while the upper and lower catches are optionally mounted to the trailer frame. The rotating handle may be rotatable around a pin 817 and also rotatable with an elongate bar or post 818, the ends of which are coupled to the upper and lower lugs. These lugs may be configured to engage the catches to secure the door in place. When closed, the lugs are urged to engage the catches to selectively hold the door in place, or to selectively allow the door to be opened when the lock mechanism is released.

The handle may be held in position by a hasp 812 which may be positioned to capture and retain the handle. The hasp optionally defines an opening 813 through which any security cable of the present disclosure may pass. An optional keeper 814 may be included that may be rotatable around a pin 815, and may also define an opening 816 through which the security cable may pass. Thus, in this example, the lock assembly includes through holes, passage ways, or other arrangements of openings in at least two portions of the mechanism through which a portion of the security seal may pass.

In operation, the lock assembly at 805 may be opened by rotating the keeper in the direction indicated at 820 to clear the handle. This frees the handle to rotate around the pin 817 in the direction shown at 821, thus clearing the handle from the hasp as it rotates toward the upper lug and keeper. Once the handle is clear of the hasp, the handle may be rotated clockwise around a central axis 819 defined by the post. The post can then selectively rotate to release the upper and lower lugs from the upper and lower keepers, thus freeing the door to open according to the rotation of the handle around the central axis. If the security seal 802 is installed and activated, the keeper cannot be rotated free of the hasp and handle unless the security cable is properly removed, or is tampered with, such as by cutting it. This is but one example of the security seal of the present disclosure in use with a particular lock mechanism. Any suitable lock mechanism may be used, such as a rotating latch common in roll-up doors, a sliding bar latch, or any other latch or lock mechanism. In another aspect, a lock mechanism of the present disclosure includes chains, straps, load binders, strap binders, or any device or assembly of devices or mechanisms for securing a load.

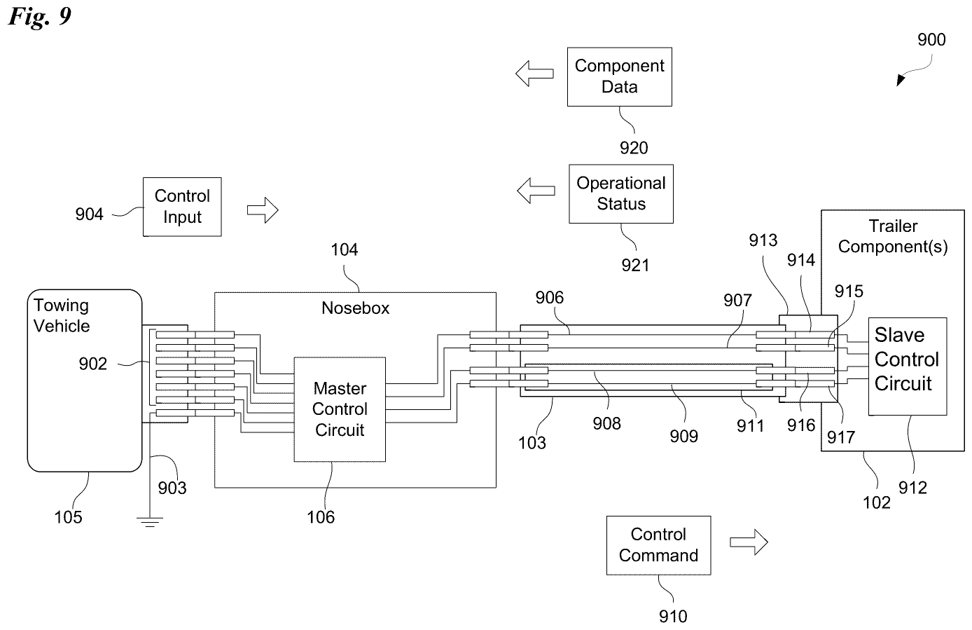

Other aspects of the trailer wiring system that may provide communication, power, and other helpful features are illustrated in FIGS. 9-14. Illustrated in FIG. 9 at 900, a nose box of the present disclosure optionally includes the master control circuit that is optionally electrically connected to multiple power terminals 902 of the towing vehicle, and to a common ground terminal 903. These multiple individual connection terminals are configured to accept power and/or control input 904 from the towing vehicle and thus the multiple connection terminals may be arranged and configured to correspond to trailer connection terminals of the towing vehicle (such as a truck towing vehicle). In the example of FIG. 9, the connection terminals include six separate power cable connections 902 and a ground cable connection 903, and the master control circuit may be electrically connected to the seven connection terminals 902, 903. These connection terminals may be included inside the nose box, or they may extend through nose box to engage a cable electrically connecting the connection terminals to the towing vehicle.

In one example, the nose box may include a connector and terminals configured to conform to the Society of Automotive Engineers (SAE) J-560 standard. Under the J-560 standard, separate circuits are included in a trailer cabling system where each circuit is dedicated to provide power to trailer components during particular modes of operation. For example, a yellow wire may be dedicated to the left turn signal and hazard lamps, a green wire may be dedicated to operate the right turn signal and hazard lamps, and a black wire may be dedicated for clearance side marker and identification lamps. In some situations, multiples of these circuits may be powered by the towing vehicle in order to activate different trailer components they are connected to at the same time. In other situations, one circuit may be selectively powered while others are not. Generally speaking, each circuit in a J-560 power distribution circuit is designed to receive power based on driver input that engages the system to operate in a particular mode of operation (e.g. turn signal to activate flashers, brake pedal pressed to activate brake lights, etc.) In this way control input 904 may be defined by the towing vehicle as it selectively provides power to one or more of separate power cable connections 902.

The master control circuit is optionally configured to accept control input from the towing vehicle via the separate power cable connections and to generate and send control commands 910 for controlling one or more individual trailer components mounted to the trailer, one example of which is the adapter and/or the security seal of the present disclosure. In another aspect, the master control circuit may be configured to send control commands to the trailer components via communication cables 908. The master control circuit may also be configured to use on or more optional additional communication cables 909 to send the control commands.

In another aspect, the trailer components may be operable to send operational status information 921, and/or component data 920 to the master control circuit via the data bus. This may include any relevant information about the security seal and/or the adapter of the present disclosure, such as notifications of outages, circuit faults, or other failures in the connectors or cables. In another aspect, the operational status information may include diagnostic or calibration data provided by the trailer components. For example, the component data 920 may include the present resistance of at least a portion of the security cable, the continuity of the security cable, or other information obtained or calculated by the security seal (and/or the adapter). This information may be used by the master control circuit to determine what, if any, actions should be taken. These actions optionally include activating or deactivating other trailer components (e.g. security lights on the inside or outside of the trailer, rear-facing security cameras, sirens, strobes, and the like) as the adapter and/or the security seal trailer components provide updates indicating whether the load has been tampered with.

In another aspect, trailer wiring system of the present disclosure optionally includes a data bus 911 that may include at least one communication cable 908, and optionally a second communication cable 909, along with the metallic power cable 906, and the metallic ground cable 907. In this configuration, the master control circuit may be configured to generate control commands for controlling the adapter and/or the security seal and to send the control commands to these components via the data bus. The control commands may be acted on by a slave control circuit 912 which is optionally included in a security seal (or the adapter) of the present disclosure. Control circuits as disclosed herein elsewhere throughout that may be included in the security seal and/or the adapter may operate as a slave control circuit, or may include a slave control circuit.

In another aspect, the security seal and/or the adapter may be coupled to the metallic power cable and the data bus by a single connector 913 having at least one power terminal 914 electrically connected to the power cable, at least two communication terminals 916 and 917 electrically connected to the data bus, and a ground terminal 915 electrically connected to a metallic ground cable of the wiring system in the trailer.

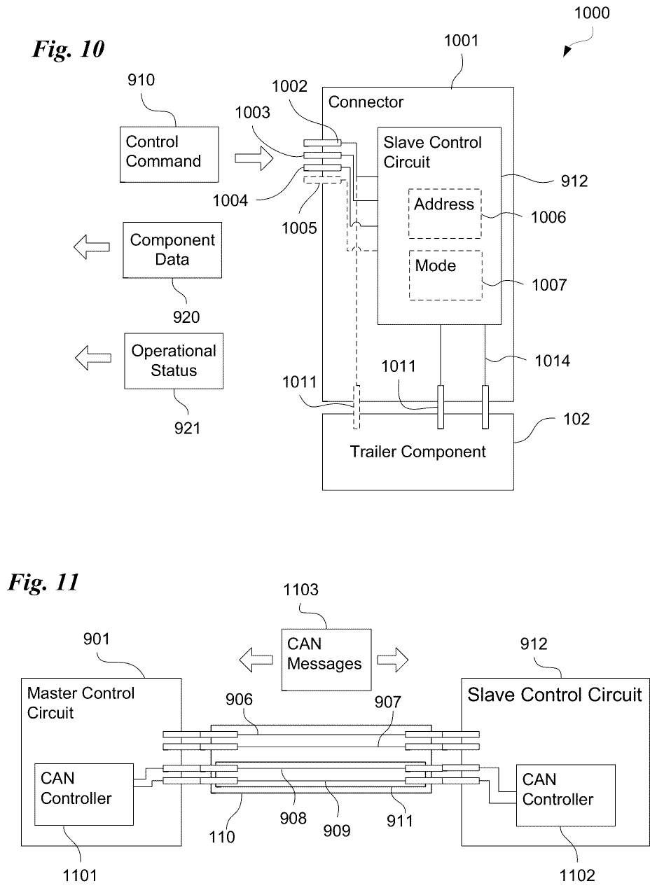

In another aspect, the slave control circuit may be mounted in a connector of the trailer that is arranged and configured to accept trailer components such as a security seal and/or an adapter of the present disclosure. One example of such a trailer connector is shown at 1000 in FIG. 10. Trailer connector 1001 optionally includes a main power connection 1002 that is electrically connected to the metallic power cable of the trailer wiring system, a ground connection that is electrically connected to the ground cable of the trailer wiring system, and at least one communication cable connection 1004, and an optional additional communication cable connection 1005 optionally electrically connected to communication cables that may be included in the trailer wiring system.

The connector provides a component power connection for the trailer components of the present disclosure via a main power connection terminal 1011 which is configured to electrically connect an individual trailer component to the power cable of the trailer wiring system. A component ground connection is provided by ground connection terminal 1014 which is configured to electrically connect the individual trailer component to the ground cable of the trailer wiring system.

Electrical connections between the power cable and power connection terminal, and between the ground cable and the ground connection terminal are optionally controlled by the slave control circuit. The slave control circuit is optionally configured to selectively electrically connect the component power connection and the component ground connection to the main power connection or the ground connection, based on input received by the at least one communication cable connection. This allows the slave control circuit to communicate with the master control circuit, and to thus activate, deactivate, or otherwise change the state of, an individual trailer component such as the security seal and/or the adapter. This may be accomplished by selectively connecting the component power and ground connections of the trailer components to the main power and/or ground connections.

In another aspect, illustrated in FIG. 10, the slave control circuit may be configured to only control the connection from ground connection terminal, while power connection terminal may be continuously connected to the power cable. In this example, the slave control circuit is optionally configured to selectively activate and deactivate the trailer component by controlling the ground connection portion of the circuit alone.

In another aspect, the main power connection, ground connection, and at least one communication cable connection electrically connects the slave control circuit to the master control circuit which may be mounted in the nose box of the trailer. In this example, the master control circuit is configured to accept control input from the towing vehicle, and is optionally configured to generate different control commands specific to the different trailer components based on control input received from the towing vehicle.

In another aspect, slave control circuit may include an address 1006 uniquely identifying slave control circuit separately from all other slave control circuits in the trailer. The slave control circuit may maintain an address 1006 in a memory such as a nonvolatile memory of the slave control circuit. In another example, the slave control circuit optionally defines an address using an arrangement of mechanical switching devices arranged in a predetermined order. In another aspect, the slave control circuit may be remotely updatable without requiring any physical manipulation to adjust the address.

In another aspect, the slave control circuit may include one or more modes 1007 identifying a single mode, or optionally multiple modes, of operation under which the slave control circuit will operate. For example, modes of operation may correspond with driver inputs such as applying input using a brake pedal, turn signal, steering wheel, transmission gear selector, or by providing user input using a user interface such as a touchscreen, buttons, and the like mounted in the operator's compartment of the towing vehicle. These modes of operation may be defined by any suitable means such as by receiving power applied to one of the separate power cable connections at the note box. In one example, some or all slave control circuits in the various connectors mounted to the trailer may be sent the same control command which may include one or more modes. The slave control circuits may receive the same command and compare the modes in the command to the modes stored in the control circuit, and then activate, deactivate, or otherwise change state as required by the detailed instructions in the command when those modes of operation specified in the control commands match the mode stored in slave control circuit.

In another aspect, the slave control circuit 912 optionally includes this address and mode behavior in the case where the slave control circuit is mounted in the trailer component directly rather than in a connector that the trailer components are coupled to. The slave control circuit is configured to compare the target mode identifier in the control commands received from the master control circuit with the mode identifier of the slave control circuit, and to activate and deactivate aspects of the rear-facing sensor, or other trailer component, when the target mode identifier matches the mode identifier of the slave control circuit.

In another aspect, illustrated in FIG. 11 the master control circuit and the slave control circuit of the present disclosure may communicate using the Control Area Network (CAN) protocol. The trailer wiring system of the present disclosure optionally includes two communication cables. The communication cable 908, may for example, operate as a CAN-high communication cable, and the communication cable 909 may optionally operate as a CAN-low communication cable. The master control circuit optionally includes a CAN master controller 1101 electrically connected to the communication cables of the data bus. The master control circuit is thus configured to send control commands to slave control circuits as messages 1103 traveling via the CAN transmission protocol. The slave control circuit may include a CAN slave controller 1102 also electrically connected to the communication cables of the data bus. In this example, the master control circuit and one or more slave control circuits may optionally communicate using the CAN protocol. In another aspect, the control commands, component data, and operational status passing between the master control circuit and the slave control circuit(s) may be carried across the data bus as message payload within the messages passed back-and-forth according to the CAN messaging protocol.

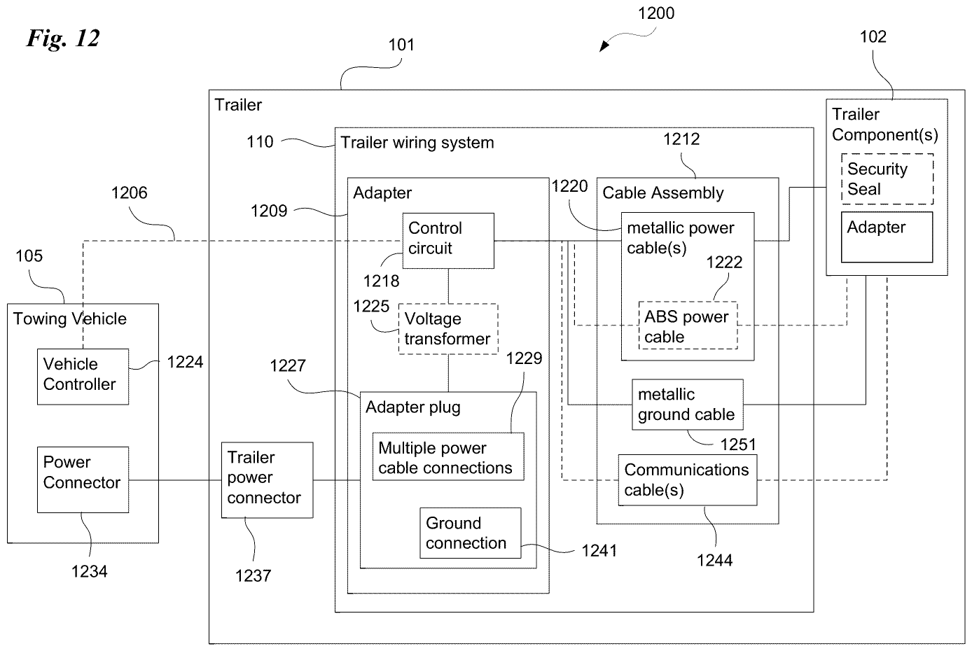

Additional optional aspects of the trailer wiring system of the present disclosure are illustrated in FIG. 12 at 1200. The trailer wiring system of the present disclosure is arranged and configured generally to carry electricity from a trailer power connector 1237 to the trailer components, which include the adapter and/or the security seal of the present disclosure. Along the way, the incoming power received from the towing vehicle may be increased in voltage, and adapted for use with a cable assembly 1212 that optionally reduces the size and number of metallic power and/or data cables in the trailer wiring system when compared with a standard seven wire trailer wiring configuration.

Examples of other trailer components that may be electrically connected to the trailer wiring system include, but are not limited to, lamps, braking system components, other sensors besides those included in the adapter and/or security seal, cameras, and/or a refrigeration system to name a few nonlimiting examples. For example, lamps may include, but are not limited to, running lamps, interior illumination lamps for lighting the interior of the trailer, side marking/clearance/identification lamps for marking extremities of the trailer, backup lamps for illuminating the area behind the trailer, license plate lamps for lighting license plates and other identifying indicia mounted on the trailer, stop or brake lamps that may illuminate when the vehicle is actively braking, tail lamps, left and right turn signal lamps and respectively, and alternatively, combination stop-tail-turn lamps.

Sensors may include any of temperature sensors for sensing the temperature in and/or around trailer, door sensor configured to optionally sense when trailer doors are open or closed, cargo sensor configured to optionally sense weight, location, and/or other attributes of cargo in or on trailer, a humidity sensor for optionally sensing absolute or relative humidity in and/or around trailer, a tank level sensor optionally for sensing the level of fluids (liquids or gases) carried by trailer, proximity sensors optionally for sensing proximity of trailer relative to nearby objects, and/or tire pressure sensors optionally for sensing pressure levels in tires on trailer 101.

Braking system trailer components may optionally include a controller for controlling the ABS braking system, an ABS lamp optionally for indicating the status or failure of the braking system, and/or a pressure sensor optionally included to sense changes in hydraulic or air pressure in braking system. Other optional trailer components include cameras such as one or more backup cameras for optionally capturing a view of the surrounding area directly behind the trailer, and one or more side cameras for optionally capturing a view of areas adjacent the sides of trailer.

Components of a refrigeration system may include a temperature sensor for determining the temperature inside the refrigerated cargo area of the trailer, a controller configure to control the refrigeration cycle in the refrigeration system, and a refrigerant level sensor for determining the level of refrigerant in the system.

The trailer wiring system of the present disclosure may receive power from the trailer power connector, which may be electrically connected to a corresponding towing vehicle power connector 1234. This initial electrical connection from the towing vehicle to the trailer may include any suitable number of wires such as 2 or more, 4, 5, or 6 wires, or 7 or more wires. For example, the towing vehicle and trailer may be electrically connected using an industry standard power cable having an SAE J-560 7-wire trailer power connector on each end. A J-560 power connecter on one end of the cable may be, for example, inserted into the towing vehicle power connector, and the J-560 power connecter on the other end of the cable may be inserted into the trailer power connector.

The trailer power connector may be electrically connected to an adapter 1209 optionally included in the trailer wiring system. The adapter may include an adapter plug 1227 having multiple power cable connection terminals 1229 and a ground connection 1241, the multiple power cable connections and the ground connection corresponding to trailer connection terminals of the towing vehicle. For example, the trailer power connector may have the seven connection terminals corresponding to the pins in a J-560 power connector, including a ground cable connection and six separate power cable connections illustrated in FIG. 9. The adapter plug may have seven connection terminals corresponding to these or other terminals in the trailer power connector. Terminals in the trailer power connector optionally correspond to connection terminals in the towing vehicle power connecter. In this way, electricity or electrical signals may be received from the truck by the trailer wiring system.

The adapter may provide power and/or transfer electrical signals to and from the trailer wiring system of the present disclosure. For example, the trailer wiring system may include a cable assembly 1212 with one or more metallic power cables 1220 electrically connected to the trailer components. The power cables may include certain power cables specific to particular systems or subsystems of the trailer. For example, the cable assembly optionally includes a power cable 1222 dedicated to provide Antilock Brake System (ABS) power and/or electrical signals to ABS related trailer components. The cable assembly may also include a metallic ground cable 1251 and optionally zero or more communication cables 1244 of the present disclosure that are configured to send and receive signals representing data and/or control signals passed to and from trailer components of the trailer. The cable assembly may thus be composed of separate metallic cables of any suitable length such as greater than 5 m long, 10 m long, or greater than 30 m long.

In another aspect, a control circuit 1218 may be included in the adapter 1209 and optionally configured to selectively electrically connect and disconnect metallic power cables 1220, metallic ground cable 1251, and the optional communication cable or cables 1244. Control circuit 1218 may be configured to send and/or receive communications signals from a plurality of the multiple components of the truck trailer using any suitable combination of cables in the cable assembly.

Control messages or signals may be sent from a control circuit 1218. In another aspect, the status or operational messages, or other signals sent by the trailer components and/or other trailer components may be received by the control circuit. For example, the control circuit 1218 may send an activation message to a trailer component. The adapter or security seal of the present disclosure may begin capturing data about the continuity of the conductive cable. This data may then be passed back to the control circuit as operational messages or signals providing the control circuit with access to real-time updates indicating whether the trailer or the load has been tampered with. Status information, as well as operational data may optionally be provided to the towing vehicle by the control circuit using an optional additional communications link such as link 1206. The control circuit 1218 may also use the communication link with the towing vehicle to communicate directly with the vehicle's internal computer or controller 1224 such as in the case of communicating with a truck's Electronic Control Unit (ECU). This link may be implemented as a wireless connection using any suitable wireless transmission technology, or as a wired connection using an additional data cable connected to an optional data port on the towing vehicle.

In one aspect, the trailer components may be operable to send a security alert, status update, or other message or signal to the control circuit 1218 as discussed herein elsewhere via the communication cables 1244. This communication may, as disclosed herein, occur using the CAN messaging protocol, or by any other suitable method of communication. The control circuit 1218 in the trailer wiring system, in the nose box for example, may communicate with the vehicle controller 1224 to notify the vehicle that a security alert has been sent by the trailer components.

The vehicle controller may be operable to respond in any suitable manner. In one example, the vehicle controller may activate an operator indicator in the cab such as a buzzer, lamp, or warning message displayed on a display device in the cab. A computer, such as a smartphone, tablet, or other computing device may be sent a warning message and the driver may be notified by a corresponding indication of security alert on a display device of the computer.

In another example, the vehicle controller may activate one or more vehicle systems that might be useful in reducing or eliminating the risk of harm or loss to the load in the trailer, or may be helpful in mitigating the losses that may have occurred when the load was accessed.

An optional voltage transformer 1225 may be included in the adapter 1209. The voltage transformer may be configured to increase the voltage provided by the multiple power cable connections and to deliver the increased voltage to the power cables of the cable assembly. The voltage transformer is optionally electrically connected to the metallic power cable(s), and to the power terminals of the multiple power cable connections.

The control circuit 1218 may be configured as a “master” node configured to send signals representing triggering data, commands, messages, or control signals to the trailer components, and to receive and process status or operational information sent from any or all of these trailer components as well. Such status information may include whether the trailer component is working properly, whether specific internal aspects of the trailer component have failed including information about which aspects are involved. Such status information may include outage of a lamp, camera malfunction, sensor failure, and the like. When the control circuit is configured as a “master”, the trailer components may be individually configured as separate, “slave” nodes as discussed herein elsewhere that receive and respond to instructional or control signals sent from the master, and that also send status information or other data to the master node.

As discussed herein elsewhere, the trailer wiring system optionally includes, a single power cable, a single ground cable, and two communications cables. The cables discussed herein that are part of the trailer wiring system, cable assemblies, data bus, and so forth, may be implemented with wire of various sizes to advantageously reduce the overall wire usage for the trailer. For example, the power cable and ground cable may have a cross-sectional area less than or equal to an 8 AWG cable, which is to say each may have a cross-sectional area of 8.4 mm2. The communications cables may have a cross-sectional area less than or equal to 18 AWG cable, which is to say these cables may have a cross-sectional area of up to 0.823 mm2 each. In this example, up to 40 A of current may be provided by the power cable at about 12 V resulting in up to about 480 W of available power but with a 43% reduction in the metallic material used as compared to a conventional J-560 compliant trailer wiring system with seven wires.

In another example, the optional voltage transformer may be configured to increase the voltage on the power cable from, for example, 12 V to 24 V. By increasing the voltage, a similar amount of power may be provided but with less current than what may be found in a conventional J-560 compliant trailer wiring system. In this example, the power cable and the ground cables of the present disclosure may have a cross-sectional area less than or equal to 12 AWG cable, which is to say each may have a cross-sectional area of up to 3.3 mm2. In this example, up to 20 A of current may be provided at about 24 V resulting in up to about 480 W of available power but with a 74% reduction in the metallic material used as compared to a conventional J-560 compliant trailer wiring system with seven wires.

In another example, the voltage transformer may increase the voltage on the power cable from, for example, 12 V to 48 V. In this example, up to 10 A of current may be provided at about 48 V resulting in up to about 480 W of available power but with a 90% reduction in the metallic material used as compared to a conventional J-560 compliant trailer wiring system with seven wires.

The truck trailer wiring system thus optionally includes a metallic ground cable, a metallic power cable, and a data bus of the present disclosure having at least one metallic communications cable. An aggregate cross-sectional area of the metallic power cable, the metallic ground cable, and each of the metallic communications cable when present, is optionally at least ten percent (10%) less than the about 32 mm2 present in a conventional J-560 compliant trailer wiring system calculated as the aggregate of:
four metallic 12 AWG cables each with a cross-sectional area of about 3.3 mm2,
two metallic 10 AWG cables each with a cross-sectional area of about 5.3 mm2,
one metallic 8 AWG cables each with a cross-sectional area of about 8.4 mm2,
Totaling the about 32 mm2 in aggregate cross-sectional area of metallic cable

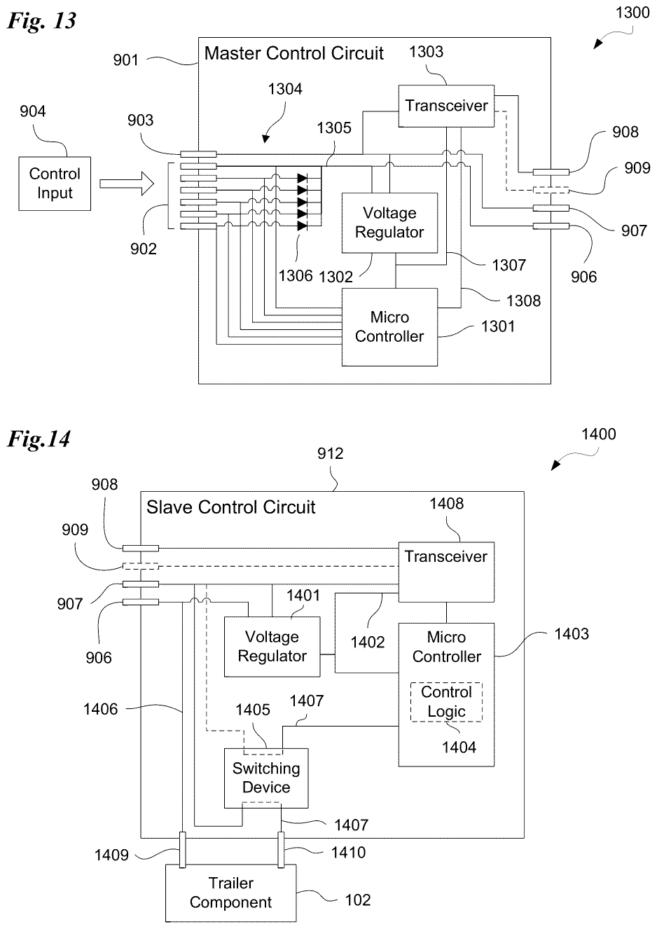

Illustrated in FIG. 13 at 1300, a master control circuit of the present disclosure optionally includes a master microcontroller 1301 electrically connected to a voltage regulator 1302 and a master transceiver 1303. In this example, the multiple separate power cable connections provided by the multiple power terminals are combined at a power junction 1304 to provide power to the master control circuit on a power cable 1305, while a connection to the common ground terminal provides a ground circuit connection for the components of the control circuit. In this example, 902 and 903 provide seven separate connections (e.g. representing seven connections of a standard J-560 power cable), six of which are coupled to power cable 1305. The diode array may be included to reduce or eliminate return currents flowing in the opposite direction from each separate power cable connection to another.

Power and ground connections within the master control circuit are provided by the voltage regulator and the ground connection. Trailer components, including the security seal or adapter of the present disclosure, that are downstream from the master control circuit, optionally receive power via the power cable 1305 and 906 and are connected to a common circuit ground via ground cable 907. A power circuit 1307 electrically connects power output from the voltage regulator to the master transceiver and the master microcontroller 1301. The power circuit 1307 may be included to provide regulated voltage and/or current to the microcontroller and transceiver of the master control circuit, and possibly to other circuits as well. For example, devices in the circuit may operate on 5 V, 3.3 V, or 12 V, or some other voltage, while power provided from the multiple power terminals bringing power into the master control circuit may be provided at 6 V, 12 V, 24 V, 48 V, or possibly other higher or lower voltages.

The communication cables optionally electrically connect the master microcontroller and transceiver to multiple slave transceivers in trailer components downstream from the master control circuit. In the case of a 4-wire trailer wiring system such as might use a CAN implementation discussed above, the communication cables optionally correspond to or operate as CAN-high and CAN-low cables.

Operational control of the master control circuit may be provided by the master microcontroller. The master microcontroller sends control signals on a master I/O circuit 1308 to other components such as the master transceiver. The control input is optionally provided to the master control circuit via the separate power cable connection terminals. Such control input includes, but is not limited to changes in voltage, changes in current levels, or as time varying signals for carrying digital or analog data to the master control circuit.

The power junction at 1304 aggregates power provided by the separate power cable connections, but also provides the master microcontroller with separate inputs for each separate power cable connection so that the master microcontroller can be configured to detect different operating modes of the towing vehicle and trailer based on different power levels on the separate power connection terminals, or by any other suitable means. The connection terminals thus operate as control inputs indicating actions to be taken by the various trailer components optionally including the trailer components.

FIG. 14 illustrates at 1400 additional components that may be included in a slave control circuit of the present disclosure. The slave control circuit optionally receives power from power cable 906 and ground cable 907 providing power and ground connections respectively to the components of the slave control circuit. A voltage regulator 1401 may be included to regulate the voltage provided via a power circuit 1402 according to the needs of a slave microcontroller 1403 and optionally some or all of the other components in the circuit such as control logic 1404, and a slave transceiver 1408. For example, the microcontroller may require 5 V, 3.3 V, or 12 V, or some other suitable voltage while power provided by the power cable may be provided at 12 V, 24 V, 48 V, or possibly at other higher or lower voltages.

A switching device 1405 may be included and may be responsive to signals from the slave microcontroller and is optionally configured to control the flow of power from the power cable to the trailer components or other trailer component coupled to the slave control circuit. For example, the switching device may include a relay configured as shown in FIG. 10 with a constant connection to the power cable being provided to the trailer components via component power circuit 1406 and a power connection terminal 1409, and a ground connection selectively provided by component activation circuit 1407 by a ground connection terminal 1410, a ground circuit electrical connection that is made based on a control output from the component control output circuit. In another aspect, the switching device may include a solid state switching device without internal physical moving parts that is configured to accept input from the component control output circuit and to selectively electrically connect the trailer components to ground.

In another aspect, the slave microcontroller may be configured to separately signal the trailer components to activate or deactivate one or more functions or features separately from the aspect of supplying or disconnecting power. The microcontroller optionally receives message data from the transceiver when a control message is sent by the master controller and received by the transceiver The slave control circuit may include the control logic 1404 which may optionally be programmed to differentiate the role of the trailer components from that of the other individual trailer components. This role may be configured by specifying one or more operating modes the slave control circuit should respond to, or by specifying an address that uniquely identifies the slave control circuit (and any trailer components it is coupled too).

For example, the slave microcontroller may optionally include control logic programmed or otherwise configured to operate trailer components such as the trailer components. In another example, the control logic is optionally configured or programmed to respond only to control commands that include an address identifier that matches the address of a particular slave control circuit. In this example, one or more trailer components may respond as a group based on an address of each slave control unit address specified in the command. In this example, the specific action to take may be defined by the type of message (e.g. “brake activation” message, “camera off” message, “software upgrade” message). As disclosed herein elsewhere, the trailer components optionally includes a slave control circuit of the present disclosure, or, the slave control circuit may be positioned within a socket, adapter, or connector that the trailer components are connectable to either physically, electrically, or both.

In another example, the present disclosure includes a trailer security system, comprising a security seal including a cable and a first and second connector electrically connected to the cable, and an adapter that includes first and second input connectors electrically connected to the first and second connectors of the security seal. The system optionally includes a third connector having at least four metal pins adapted for receiving both electrical power and digital electrical signals, the third connector electrically connected to the trailer, and an adapter control circuit electrically connected to the at least four metal pins, and to the first and second analog input terminals, wherein the adapter control circuit is operable to monitor the electrical continuity of the security cable via the first and second input terminals. The system optionally further includes a remote monitoring system executing on one or more processors of one or more computers, and a master control circuit in the trailer, wherein the master control circuit is in communication with the adapter control circuit in the adapter, and with the remote monitoring system via one or more communication links, wherein the adapter control circuit is configured to send status updates to the master control circuit indicating the state of the security seal, wherein the master control circuit is configured to accept the status updates and to generate a security update and send it to the remote monitoring service via a communication link with the remote monitoring service, and wherein the remote monitoring system is configured to receive security updates from the master control circuit and to send an alert message to a personal computing device when the security update indicates the security seal has been broken.

In another aspect, the cable is operable to pass through at least a portion of a locking assembly of the trailer, and wherein the locking assembly is arranged and configured to selectively hold a door of the trailer in a locked state, and/or the master control circuit may be configured to send an alert to the remote monitoring system when the electrical continuity of the security cable is broken.

In another aspect, the master control circuit is configured to send an alert to the remote monitoring system when the electrical connection between the adapter and the master control circuit is lost, and/or the adapter control circuit is operable to send an alert to the master control circuit when the electrical continuity of the security cable is broken. The remote monitoring system may be configured receive an alert sent from the master control circuit and to send a corresponding security notification to one or more other computing devices.

In another aspect, the remote monitoring system is configured to receive location data defining a geographical location of either the master control circuit, the adapter control circuit, or both. Optionally, either the master control circuit, or the adapter control circuit, or both, further comprise a location finding module operable to determine a geographical location of the location finding module, and by extension the vehicle the master control circuit is mounted in or on. The remote monitoring system is optionally configured to store boundary data defining one or more geographical areas.

In another aspect the remote monitoring system may be configured to determine when the master control circuit or the adapter control circuit are outside at least one of the one or more geographical areas using the location data. The remote monitoring system may be configured to send a security alert to one or more other computing devices indicating that the seal has been broken outside the at least one or more geographical areas. The remote monitoring system may be configured to determine when the master control circuit or the adapter control circuit are inside at least one of the one or more geographical areas using the location data.

In another aspect, the remote monitoring system is optionally configured to refrain from sending a security alert to one or more other computing devices when the seal has been broken inside the at least one or more geographical areas.

In another aspect, the adapter control circuit optionally includes a memory storing an identifier that identifies the adapter as being different than other adapters of other security seals. In another aspect, the security seal includes a resistor electrically connected in series with the cable, and/or the resistor may be electrically connected between the first and second connectors. The first and second connectors may be mounted at opposing ends of the cable. Optionally, the first and second connectors are arranged and configured to be insertable into the first and second input connectors of the adapter.

In another aspect the adapter control circuit optionally includes a transceiver that is arranged and configured to receive the digital electrical signals from the third connector via an electrical connection with at least one digital input pin of the third connector, and wherein the transceiver includes at least one data output terminal. The adapter control circuit optionally includes a microcontroller that has at least one input terminal electrically connected to the at least one data output terminal of the transceiver. The transceiver optionally includes a Control Area Network (CAN) controller and a CAN transceiver electrically connected to the CAN controller and the data output terminal of the transceiver, and/or the CAN transceiver is responsive to commands received from the master control circuit in the trailer. The digital electrical signals may conform to the CAN protocol. Accordingly, the at least four metal pins may include a power pin, a ground pin, and two data pins.

In another aspect, the present disclosure includes a security seal for a trailer door, comprising an electrically conductive security cable, an analog input terminal arranged and configured to receive one end of the security cable, and a trailer wiring connector having at least four terminals adapted for receiving both electrical power and digital electrical signals. The seal may include a control circuit electrically connected to the at least four terminals of the trailer wiring connector, the security cable, and the analog input terminal. The control circuit may be operable to detect changes in electrical resistance of the security cable. Along those lines, a resistor electrically connected in series with the cable may be included such that the control circuit monitors the electrical resistance of the security cable and the resistor.

In another aspect, the security seal optionally comprises a housing containing the control circuit, wherein one end of the security cable is mounted to the housing, wherein the analog input terminal is mounted to the housing, and wherein a second opposing end of the security cable is selectively insertable into the analog input terminal. The analog input terminal optionally defines a cavity arranged and configured to receive the one end of the security cable.

The system and techniques as described and illustrated herein concern a number of unique and inventive aspects. Some, but by no means all, of these unique aspects are summarized below:

Aspect 1 generally concerns components of a security system that include, but are not limited to, a security seal, adapter for a trailer component, and a security service.

Aspect 2 generally concerns any previous aspect, including that the security system can be used to secure various vehicles such as a bus, trailer, ship, barge, or aircraft.

Aspect 3 generally concerns any previous aspect including, that the system may be used on a vehicle (such as a trailer) directly or on individual items, containers, boxes, or other objects.

Aspect 4 generally concerns any previous aspect including, an adapter of a trailer that is electrically connected to a security seal.

Aspect 5 generally concerns any previous aspect, including that in some instances, the security seal may be a trailer component and may not require an additional adapter.

Aspect 6 generally concerns any previous aspect, including that a trailer wiring system connects trailer components to a master control circuit.

Aspect 7 generally concerns any previous aspect, including that the trailer may include a closure (door, gate, cable, strap) and a lock mechanism to secure it.

Aspect 8 generally concerns any previous aspect, including that the trailer can be coupled to a towing vehicle and may also be used to tow other trailers.

Aspect 9 generally concerns any previous aspect, including trailer components can be mounted inside, outside, or both on the trailer in any suitable combination.

Aspect 10 generally concerns any previous aspect, including that the trailer components can include lamps, cameras, ABS controllers, tire pressure sensors, cargo sensors, motion sensors, and proximity sensors.

Aspect 11 generally concerns any previous aspect, including that the trailer wiring system carries signals and power to various subsystems.

Aspect 12 generally concerns any previous aspect, including that the wiring system can electrically and/or physically connect trailer components to each other, to the trailer wiring system, to a nosebox, and to the master control circuit, in any combination.

Aspect 13 generally concerns any previous aspect, including that the wiring system may connect to the towing vehicle and optionally to subsequent trailers.

Aspect 14 generally concerns any previous aspect, including that the towing vehicle may have logical, physical, electrical, or wireless connections to the trailer.

Aspect 15 generally concerns any previous aspect, including that the master control circuit can communicate with the security seal, and/or with an adapter that may be coupled thereto.

Aspect 16 generally concerns any previous aspect, including that the master control circuit communicates with multiple trailer components via the wiring system.

Aspect 17 generally concerns any previous aspect, including that the master control circuit can determine component outages, collect status information, and relay it to remote servers.

Aspect 18 generally concerns any previous aspect, including that the master control circuit can communicate with remote services, the towing vehicle, and manage power/data flow between trailer components.

Aspect 19 generally concerns any previous aspect, including that the master control circuit is configured to generate security updates and sends them to a remote monitoring service.

Aspect 20 generally concerns any previous aspect, including that the master control circuit is operable to establish/maintain communication links with a remote monitoring service.

Aspect 21 generally concerns any previous aspect, including that the master control circuit accepts status updates from trailer components, including the security seal and/or the adapter(s).

Aspect 22 generally concerns any previous aspect, including that the master control circuit can send alerts to a remote security service when it detects broken security cables, tampering, and/or lost connections, or any combination thereof.

Aspect 23 generally concerns any previous aspect, including that the master control circuit is operable to determine and include its geographical location on the earth in alerts or other communication to a remote service.

Aspect 24 generally concerns any previous aspect, including that the lock mechanism is operable to permit selective opening/closing of a closure such as a door, or a clasp, latch, cable tie, and the like.

Aspect 25 generally concerns any previous aspect, including that the lock mechanism may define openings through which a portion of a security device may pass.

Aspect 26 generally concerns any previous aspect, including that trailer components and the master control circuit may communicate using a digital protocol.

Aspect 27 generally concerns any previous aspect, including that the adapter is configured to convert analog input from a security seal to digital signals.

Aspect 28 generally concerns any previous aspect, including that the wiring system communicates data using a network protocol like CAN.

Aspect 29 generally concerns any previous aspect, including that the master control circuit and some/all trailer components optionally operate as nodes on the network.

Aspect 30 generally concerns any previous aspect, including that the security seal is operable to alert remote systems or parties when tampering with the security seal occurs.

Aspect 31 generally concerns any previous aspect, including that the security seal may include an electrically conductive and/or resistive aspect.

Aspect 32 generally concerns any previous aspect, including that the adapter interfaces between the security seal and the trailer wiring system.

Aspect 33 generally concerns any previous aspect, including that the adapter is configured to monitor the security seal for breaks or tampering.

Aspect 34 generally concerns any previous aspect, including that the adapter is configured to measure/determine the electrical resistance of the security seal.

Aspect 35 generally concerns any previous aspect, including that the adapter is configured to determine resistance changes and send data to the master control circuit.

Aspect 36 generally concerns Status information from the security seal is configured to be sent to a personal computing device and/or a remote monitoring service.

Aspect 37 generally concerns any previous aspect, including that the security seal is configured to include a cable with connectors.

Aspect 38 generally concerns any previous aspect, including that the cable is configured to be electrically conductive.

Aspect 39 generally concerns any previous aspect, including that the connectors are configured to connect the cable to the adapter or the security seal.

Aspect 40 generally concerns any previous aspect, including that the cable is configured to pass through the locking assembly.

Aspect 41 generally concerns any previous aspect, including that the adapter includes a memory, analog input connectors, a data connector, and a power connector, and is configured to establish and/or maintain a communication link.

Aspect 42 generally concerns any previous aspect, including that the adapter memory is configured to store an identifier.

Aspect 43 generally concerns any previous aspect, including that the adapter is configured to send data to the nosebox/master control circuit.

Aspect 44 generally concerns Any previous aspect, including that the data and power pins are configured to be separate electrical connections of a single connector.

Aspect 45 generally concerns any previous aspect, including that the security cable is configured to be electrically connected between the adapter's input connectors.

Aspect 46 generally concerns any previous aspect, including that the cable is configured to be partially resistive with a predetermined nominal resistance.

Aspect 47 generally concerns any previous aspect, including that the adapter is configured to send alerts about changes in the continuity of the security cable.

Aspect 48 generally concerns any previous aspect, including that the adapter is configured to communicate wirelessly (e.g., WiFi, Bluetooth).

Aspect 49 generally concerns any previous aspect, including that the adapter may include location-finding circuits.

Aspect 50 generally concerns any previous aspect, including that the adapter is configured to include location data in status updates/alerts it may send.

Aspect 51 generally concerns any previous aspect, including that the adapter is configured to send continuous resistance data to the master control circuit.

Aspect 52 generally concerns any previous aspect, including that the master control circuit is configured to include memory, processor, control logic, and location-finding circuitry.

Aspect 53 generally concerns any previous aspect, including that the master control circuit is configured to compare resistance data to predetermined levels.

Aspect 54 generally concerns any previous aspect, including that the remote monitoring service is configured to communicate with personal computing devices.

Aspect 55 generally concerns any previous aspect, including that the personal computing devices are configured to notify users via SMS, notifications, email, or by any other suitable means.

Aspect 56 generally concerns any previous aspect, including that the personal computing devices are configured to notify other systems.

Aspect 57 generally concerns any previous aspect, including that the updates from trailer components are configured to include location data.

Aspect 58 generally concerns any previous aspect, including that the updates are configured to be status updates or security alerts.

Aspect 59 generally concerns any previous aspect, including that the security service is configured to generate an alert from a status update.

Aspect 60 generally concerns any previous aspect, including that GPS, GLONASS, mobile signal tracking, Wi-Fi, and Bluetooth may be used for location finding in any of the systems that include location finding aspects.

Aspect 61 generally concerns any previous aspect, including that the remote monitoring service is configured to accept status updates and send them to personal computing devices.

Aspect 62 generally concerns any previous aspect, including that the remote monitoring service is configured to receive location data for the master control circuit and/or adapter.

Aspect 63 generally concerns any previous aspect, including that the remote monitoring service includes servers, processors, running processes, an event log, a data store, and control logic.

Aspect 64 generally concerns any previous aspect, including that the data store is configured to store boundary data and triggering rules.

Aspect 65 generally concerns any previous aspect, including that the geographical areas are defined by polygons approximating various features (buildings, political boundaries, natural features, roads, etc.).

Aspect 66 generally concerns any previous aspect, including that the “safe” zones are defined as areas wherein the sending of alerts is suppressed when alerts are generated within the zones.

Aspect 67 generally concerns any previous aspect, including that the remote monitoring service is configured to determine if a location is inside or outside a defined geographical area.

Aspect 68 generally concerns any previous aspect, including that the remote monitoring service is configured to use triggering rules and boundary data to determine alert types and recipients.

Aspect 69 generally concerns any previous aspect, including that the remote monitoring service is configured to refrain from sending alerts in certain areas.

Aspect 70 generally concerns any previous aspect, including that the security seal is configured to have a cable with connection terminals.

Aspect 71 generally concerns any previous aspect, including that the adapter is configured to have analog input connectors that optionally include a retention mechanism.

Aspect 72 generally concerns any previous aspect, including that the adapter includes a third connector with power, ground, and communication terminals.

Aspect 73 generally concerns any previous aspect, including that the adapter includes a control circuit to monitor cable continuity.

Aspect 74 generally concerns any previous aspect, including that the adapter includes a memory for storing an identifier, events, alerts, or other data.

Aspect 75 generally concerns any previous aspect, including that the security cable is configured to be electrically conductive, resistive, or any combination thereof.

Aspect 76 generally concerns any previous aspect, including that a resistor is configured to be included separately or as part of the security cable.

Aspect 77 generally concerns any previous aspect, including that the security cable includes conductive strands or fibers.

Aspect 78 generally concerns any previous aspect, including that the security cable includes non-conductive strands.

Aspect 79 generally concerns any previous aspect, including that the strands in the security cable define differing cross-sectional areas.

Aspect 80 generally concerns any previous aspect, including that the security cable comprises a protective layer (such as a sheath, coating, and the like).

Aspect 81 generally concerns any previous aspect, including that the protective layer includes or incorporates differing materials (such as polymeric, metallic, Fiberglass®, Kevlar®, or other fibers or strands).

Aspect 82 generally concerns any previous aspect, including that the security seal is configured to be used with various lock mechanisms.

Aspect 83 generally concerns any previous aspect, including that the trailer nosebox contains the master control circuit.

Aspect 84 generally concerns any previous aspect, including that the nosebox is configured to connect to multiple power terminals and a ground terminal of the towing vehicle.

Aspect 85 generally concerns any previous aspect, including that the nosebox is configured to accept control input from the towing vehicle.

Aspect 86 generally concerns any previous aspect, including that the master control circuit is configured to send control commands to trailer components.

Aspect 87 generally concerns any previous aspect, including that the trailer components are configured to send operational status and component data to the master control circuit via a data bus.

Aspect 88 generally concerns any previous aspect, including that the trailer wiring system is configured to include a data bus with communication cables, power cable, and ground cable.

Aspect 89 generally concerns any previous aspect, including that the security seal/adapter is configured to connect to the power cable and data bus via a single connector.

Aspect 90 generally concerns any previous aspect, including that the slave control circuit is included in the security seal/adapter or a connector electrically connected thereto.

Aspect 91 generally concerns any previous aspect, including that the trailer connector includes power, ground, and communication connections.

Aspect 92 generally concerns any previous aspect, including that the slave control circuit is configured to control power/ground connections to trailer components electrically connected thereto.

Aspect 93 generally concerns any previous aspect, including that the slave control circuit is configured to retain a unique address with one or more predetermined operating modes.

Aspect 94 generally concerns any previous aspect, including that the master and slave control circuits are configured to communicate using the CAN protocol.

Aspect 95 generally concerns any previous aspect, including that the trailer wiring system includes a cable assembly with dedicated power cables and communication cables.

Aspect 96 generally concerns any previous aspect, including that the adapter in the trailer wiring system is configured to selectively connect/disconnect cables from the adapter.

Aspect 97 generally concerns any previous aspect, including that the control circuit in the adapter is configured to send/receive communication signals.

Aspect 98 generally concerns any previous aspect, including that the master control circuit is configured to communicate with a vehicle controller of the towing vehicle.

Aspect 99 generally concerns any previous aspect, including that a voltage transformer is included that is configured to increase the voltage in the trailer wiring system.

Aspect 100 generally concerns any previous aspect, including that the trailer wiring system is configured to use smaller gauge wires to reduce material usage.

Aspect 101 generally concerns any previous aspect, including that the master control circuit is configured to include a microcontroller, voltage regulator, and transceiver.

Aspect 102 generally concerns any previous aspect, including that the slave control circuit is configured to include a microcontroller, voltage regulator, transceiver, switching device, and control logic.

### Glossary of Definitions and Alternatives

While the invention is illustrated in the drawings and described herein, this disclosure is to be considered as illustrative and not restrictive in character. The present disclosure is exemplary in nature and all changes, equivalents, and modifications that come within the spirit of the invention are included. The detailed description is included herein to discuss aspects of the examples illustrated in the drawings for the purpose of promoting an understanding of the principles of the invention. No limitation of the scope of the invention is thereby intended. Any alterations and further modifications in the described examples, and any further applications of the principles described herein are contemplated as would normally occur to one skilled in the art to which the invention relates. Some examples are disclosed in detail, however some features that may not be relevant may have been left out for the sake of clarity.

Where there are references to publications, patents, and patent applications cited herein, they are understood to be incorporated by reference as if each individual publication, patent, or patent application were specifically and individually indicated to be incorporated by reference and set forth in its entirety herein.

Singular forms “a”, “an”, “the”, and the like include plural referents unless expressly discussed otherwise. As an illustration, references to “a device” or “the device” include one or more of such devices and equivalents thereof.

Directional terms, such as “up”, “down”, “top” “bottom”, “fore”, “aft”, “lateral”, “longitudinal”, “radial”, “circumferential”, etc., are used herein solely for the convenience of the reader in order to aid in the reader's understanding of the illustrated examples. The use of these directional terms does not in any manner limit the described, illustrated, and/or claimed features to a specific direction and/or orientation.

Multiple related items illustrated in the drawings with the same part number which are differentiated by a letter for separate individual instances, may be referred to generally by a distinguishable portion of the full name, and/or by the number alone. For example, if multiple “laterally extending elements” 90A, 90B, 90C, and 90D are illustrated in the drawings, the disclosure may refer to these as “laterally extending elements 90A-90D,” or as “laterally extending elements 90,” or by a distinguishable portion of the full name such as “elements 90”.

The language used in the disclosure are presumed to have only their plain and ordinary meaning, except as explicitly defined below. The words used in the definitions included herein are to only have their plain and ordinary meaning. Such plain and ordinary meaning is inclusive of all consistent dictionary definitions from the most recently published Webster's and Random House dictionaries. As used herein, the following definitions apply to the following terms or to common variations thereof (e.g., singular/plural forms, past/present tenses, etc.):

“About” with reference to numerical values generally refers to plus or minus 10% of the stated value. For example, if the stated value is 4.375, then use of the term “about 4.375” generally means a range between 3.9375 and 4.8125.

“Activate” generally is synonymous with “providing power to”, or refers to “enabling a specific function” of a circuit or electronic device that already has power.

“Alert” generally refers to an audible and/or visual message intended to inform a system's users or administrators about a change in the operating conditions of the system or about an error condition of the system. In a graphical user interface, the alert may be displayed as a small window containing a message and/or photo detailing the alert information and parameters. In some examples, the alert may include a button (virtual or physical) to click in order to dismiss the alert. In other examples, the alert may be strictly audible and based on preset parameters. In a further example, the alert may be transmitted to a remote device for analysis. Other synonymous terms for alert include alarm and/or notification.

“And/or” is inclusive here, meaning “and” as well as “or”. For example, “P and/or Q” encompasses, P, Q, and P with Q; and, such “P and/or Q” may include other elements as well.

“Anti-lock Braking System” generally refers to a vehicle safety system that allows the wheels on a motor vehicle (including trailers) to maintain tractive contact with the road surface according to driver inputs while braking, preventing the wheels from locking up (ceasing rotation) and avoiding uncontrolled skidding. ABS systems automatically apply the principles of threshold braking and cadence braking albeit a much faster rate and with better control than drivers can typically manage manually. ABS systems include wheel speed sensors to detect reduced wheel rotation indicative of impending wheel lock. An ABS controller is also included that can automatically actuate the braking system to reduce braking force on the affected wheel or wheels, and to quickly reapply braking force when the danger of wheel lock is reduced. This overall feedback loop may be executed multiple times a second resulting in rapid activation and deactivation of braking force or “pulsing” of the brakes. Maximum braking force is obtained with approximately 10-20% slippage between the braked wheel's rotational speed and the road surface. Beyond this point, rolling grip diminishes rapidly and sliding friction provides a greater proportion of the force that slows the vehicle. Due to local heating and melting of the tires, the sliding friction can be very low. When braking at, or beyond, the peak braking force, steering input is largely ineffective since the grip of the tire is entirely consumed in braking the vehicle. Threshold braking seeks to obtain peak friction by maintaining the maximum braking force possible without allowing wheels to slip excessively. Braking beyond the slipping point causes tires to slide and the frictional adhesion between the tire and driving surface is thus reduced. The aim of threshold braking is to keep the amount of tire slip at the optimal amount, the value that produces the maximum frictional, and thus braking force. When wheels are slipping significantly (kinetic friction), the amount of friction available for braking is typically substantially less than when the wheels are not slipping (static friction), thereby reducing the braking force. Peak friction occurs between the static and dynamic endpoints, and this is the point that threshold braking tries to maintain. “Cadence” braking or “stutter” braking involves pumping the brake pedal and is used to allow a car to both steer and brake on a slippery surface. ABS systems generally provide this behavior automatically and at a much higher rate than most drivers can manually produce. It is used to effect an emergency stop where traction is limited to reduce the effect of skidding from road wheels locking up under braking. This can be a particular problem when different tires have different traction, such as on patchy ice for example. Cadence braking maximizes the time for the driver to steer around the obstacle ahead, as it allows the driver to steer while slowing. ABS generally offers improved vehicle control and decreases stopping distances on dry and slippery surfaces; however, on loose gravel or snow-covered surfaces, ABS can significantly increase braking distance, although still improving vehicle steering control.

“Brake Lamp” generally refers to a lamp (usually red) attached to the rear of a vehicle that illuminates when the brakes are applied to serve as a warning to fellow drivers. As used herein, the term “brake lamp” includes stop lamps as that term is defined under the present legal and/or regulatory requirements for a truck or a trailer such as illuminated surface area, candela, and otherwise. Such regulations include, for example, Title 49 of the U.S. Code of Federal Regulations, section 571.108, also known as Federal Motor Vehicle Safety Standard (FMVSS) 108.

“Cable” generally refers to one or more elongate strands of material that may be used to carry electromagnetic or electrical energy. A metallic or other electrically conductive material may be used to carry electric current. In another example, strands of glass, acrylic, or other substantially transparent material may be included in a cable for carrying light such as in a fiber-optic cable. A cable may include connectors at each end of the elongate strands for connecting to other cables to provide additional length. A cable is generally synonymous with a node in an electrical circuit and provides connectivity between elements in a circuit but does not include circuit elements. Any voltage drop across a cable is therefore a function of the overall resistance of the material used.

A cable may include a sheath or layer surrounding the cable with electrically non-conductive material to electrically insulate the cable from inadvertently electrically connecting with other conductive material adjacent the cable.

A cable may include multiple individual component cables, wires, or strands, each with, or without, a non-conductive sheathing. A cable may also include a non-conductive sheath or layer around the conductive material, as well as one or more layers of conductive shielding material around the non-conductive sheath to capture stray electromagnetic energy that may be transmitted by electromagnet signals traveling along the conductive material of the cable, and to insulate the cable from stray electromagnetic energy that may be present in the environment the cable is passing through. Examples of cables include twisted pair cable, coaxial cable, “twin-lead”, fiber-optic cable, hybrid optical and electrical cable, ribbon cables with multiple side-by-side wires, and the like.

“Computer” generally refers to any computing device configured to compute a result from any number of input values or variables. A computer may include a processor for performing calculations to process input or output. A computer may include a memory for storing values to be processed by the processor, or for storing the results of previous processing.

A computer may also be configured to accept input and output from a wide array of input and output devices for receiving or sending values. Such devices include other computers, keyboards, mice, visual displays, printers, industrial equipment, and systems or machinery of all types and sizes. For example, a computer can control a network or network interface to perform various network communications upon request. The network interface may be part of the computer, or characterized as separate and remote from the computer.

A computer may be a single, physical, computing device such as a desktop computer, a laptop computer, or may be composed of multiple devices of the same type such as a group of servers operating as one device in a networked cluster, or a heterogeneous combination of different computing devices operating as one computer and linked together by a communication network. The communication network connected to the computer may also be connected to a wider network such as the internet. Thus, a computer may include one or more physical processors or other computing devices or circuitry, and may also include any suitable type of memory.

A computer may also be a virtual computing platform having an unknown or fluctuating number of physical processors and memories or memory devices. A computer may thus be physically located in one geographical location or physically spread across several widely scattered locations with multiple processors linked together by a communication network to operate as a single computer.

The concept of “computer” and “processor” within a computer or computing device also encompasses any such processor or computing device serving to make calculations or comparisons as part of the disclosed system. Processing operations related to threshold comparisons, rules comparisons, calculations, and the like occurring in a computer may occur, for example, on separate servers, the same server with separate processors, or on a virtual computing environment having an unknown number of physical processors as described above.

A computer may be coupled to one or more visual displays and/or may include an integrated visual display. Likewise, displays may be of the same type, or a heterogeneous combination of different visual devices. A computer may also include one or more operator input devices such as a keyboard, mouse, touch screen, laser or infrared pointing device, or gyroscopic pointing device to name just a few representative examples. Also, besides a display, one or more other output devices may be included such as a printer, plotter, industrial manufacturing machine, 3D printer, and the like. As such, various display, input and output device arrangements are possible.

Multiple computers or computing devices may be configured to communicate with one another or with other devices over wired or wireless communication links to form a network. Network communications may pass through various computers operating as network appliances such as switches, routers, firewalls or other network devices or interfaces before passing over other larger computer networks such as the internet. Communications can also be passed over the network as wireless data transmissions carried over electromagnetic waves through transmission lines or free space. Such communications include using WiFi or other Wireless Local Area Network (WLAN) or a cellular transmitter/receiver to transfer data.

“Communication System” generally refers to an arrangement of cooperating devices or systems configured to communicate with each other. The communication system may use electric or non-electric sources such as graphic images, electromagnetic radiation, the human voice, digital or analog data, and the like, and may carry information provided by these sources as electric or nonelectric signals.

A communication system may include input transducers or sensors to capture input from the sources. Such sensors may include microphones, cameras, keyboards, motion sensors, light sensors, or other such transducers for capturing some aspect from one location or environment and converting or capturing it as input. A transmitter may be included to convert captured information from the input sources into electric signals and may include aspects such as noise filters, analog-to-digital converters, encoders, modulators, signal amplifiers, and the like to prepare the captured input for transmission. Transmission may be achieved by an antenna, or any suitable device for converting the input to electromagnetic energy in any suitable form.

A receiver may be included to accept signals from a transmitter via a receiving antenna, the receiver may be configured to capture and reconstruct the signal as it was before transmission. The receiver may include components such as noise filters, digital to analog converters, decoders, demodulators, signal amplifiers, and the like. An output transducer may be included that is coupled to the receiver in any suitable way and is configured to convert the signals from a receiver to a different form such as the original form the information was in before it was transmitted. Such output transducers may include speakers for audio output, monitors displaying visual output, motors or actuators for translating the transmitted signal into movement or motion, lights, or other devices responsive to a signal output by the receiver.

“Communications cable” generally refers to a cable configured to carry digital or analog signals.

“Communication Link” generally refers to a connection between two or more communicating entities and may or may not include a communications channel between the communicating entities. The communication between the communicating entities may occur by any suitable means. For example, the connection may be implemented as a physical link, an electrical link, an electromagnetic link, a logical link, or any other suitable linkage facilitating communication.

In the case of a physical link, communication may occur by multiple components in the communication link configured to respond to one another by physical movement of one element in relation to another. In the case of an electrical link, the communication link may be composed of multiple electrical conductors electrically connected to form the communication link.

In the case of an electromagnetic link, the connection may be implemented by sending or receiving electromagnetic energy at any suitable frequency, thus allowing communications to pass as electromagnetic waves. These electromagnetic waves may or may not pass through a physical medium such as an optical fiber, or through free space via one or more sending and receiving antennas, or any combination thereof. Electromagnetic waves may be passed at any suitable frequency including any frequency in the electromagnetic spectrum.

A communication link may include any suitable combination of hardware which may include software components as well. Such hardware may include routers, switches, networking endpoints, repeaters, signal strength enters, hubs, and the like.

In the case of a logical link, the communication link may be a conceptual linkage between the sender and recipient such as a transmission station in the receiving station. Logical link may include any combination of physical, electrical, electromagnetic, or other types of communication links.

“Control Area Network (CAN)” generally refers to a communication system and network protocol that may be used for intercommunication between components or subsystems of a vehicle. A CAN (sometimes referred to colloquially as a “CAN bus”) allows one or more microcontrollers or CAN enabled devices to communicate with each other in real time without a host computer. A CAN may physically connect all nodes together through a two wire bus. The wires may be a twisted pair cable with a 120-ohm characteristic impedance. These wires may be thought of as “high” and “low” connections.

CAN may be thought of as an example of a multi-master serial bus for connecting Electronic Control Units (ECUs) also referred to as “nodes”. Two or more nodes are required on the CAN network to communicate. The complexity of the node can range from a simple I/O device such as a sensor, an active device such as a lamp, transmission, or brake actuator, or an embedded computer or ECU with a CAN interface. A node may also be a gateway allowing a standard computer to communicate over a network connection such as a Universal Serial Bus (USB) or Ethernet port allowing outside devices to be selectively added or removed from the CAN network.

A CAN bus does not require any addressing schemes, as the nodes of the network use unique identifiers that may be provided by programming the individual node before use, or reprogramming between uses. This provides the nodes with information regarding the priority and the urgency of transmitted message.

Each node may include a central processing unit, microprocessor, or host processor. The host processor may be configured to determine what the received messages mean and what messages to transmit in response. A node may be electrically connected to sensors, actuators, lamps, or other electronic devices that can be connected to the host processor. A node may also include a CAN controller, optionally integrated into the microcontroller. The can control may implement the sending and receiving protocols. When receiving, the CAN controller may store the received serial bits from the bus until an entire message is available, which can then be fetched by the host processor (for example, by the CAN controller triggering an interrupt). When sending, the host processor may send the transmit message(s) to the CAN controller, which transmits the bits serially onto the bus when the bus is free. A node may also include a transceiver. When receiving: the transceiver may convert the data stream from CAN bus levels to levels that the CAN controller uses. It may have protective circuitry to protect the CAN controller. When transmitting, the transceiver may convert the data stream from the CAN controller to CAN bus levels.

Each node may be configured to send and receive messages, but not simultaneously. A message or Frame consists primarily of the ID (identifier), which represents the priority of the message, and up to eight data bytes. A CRC, acknowledge slot (ACK) and other overhead are also part of the message. The improved CAN FD extends the length of the data section to up to 64 bytes per frame. The message is transmitted serially onto the bus using a non-return-to-zero (NRZ) format and may be received by all nodes.

CAN data transmission may use a lossless bitwise arbitration method of contention resolution. This arbitration method may require all nodes on the CAN network to be synchronized to sample every bit on the CAN network at the same time. Thus, data may be transmitted without a clock signal in an asynchronous format.

The CAN specifications may use the terms “dominant” bits and “recessive” bits where dominant is a logical 0 (actively driven to a voltage by the transmitter) and recessive is a logical 1 (passively returned to a voltage by a resistor). The idle state may be represented by the recessive level (logical 1). If one node transmits a dominant bit and another node transmits a recessive bit then a collision results and the dominant bit “wins”. This means there is no delay to the higher-priority message, and the node transmitting the lower priority message automatically attempts to retransmit, for example, six bit clocks after the end of the dominant message.

All nodes on the CAN network generally operate at the same nominal bit rate, but noise, phase shifts, oscillator tolerance and oscillator drift mean that the actual bit rate may not be the same as the nominal bit rate. Since a separate clock signal is not used, a means of synchronizing the nodes is used. Synchronization is helpful during arbitration since the nodes in arbitration may see both their transmitted data and the other nodes' transmitted data at the same time. Synchronization is also helpful to ensure that variations in oscillator timing between nodes do not cause errors.

Synchronization may start with a hard synchronization on the first recessive to dominant transition after a period of bus idle (the start bit). Resynchronization may occur on every recessive to dominant transition during the frame. The CAN controller may expect the transition to occur at a multiple of the nominal bit time. If the transition does not occur at the exact time the controller expects it, the controller adjusts the nominal bit time accordingly.

Examples of lower-layer (e.g. levels 1 and 2 of the ISO/OSI model), are commercially available from the International Standardization Organization (ISO) and include ISO 11898-1 through 11898-6, as well as ISO 16845-1 and 16845-2.

CAN standards may not include application layer protocols, such as flow control, device addressing, and transportation of data blocks larger than one message, as well as, application data. Other CAN standards are available that are optimized for specific fields of use. These include, but are not limited to:
ARINC 812 or ARINC 825 (for the aviation industry)
CANopen—EN 50325-4 (used for industrial automation)
DeviceNet (used for industrial automation)
EnergyBus—CiA 454 (used for light electrical vehicles)
ISOBUS—ISO 11783 (agriculture)
ISO-TP—ISO 15765-2 (Transport protocol for automotive diagnostic)
SAE J1939 (In-vehicle network for buses and trucks)
MilCAN
NMEA 2000—IEC 61162-3 (marine industry)
Unified Diagnostic Services (UDS)—ISO 14229 (automotive diagnostics)
CANaerospace—Stock (for the aviation industry)
CAN Kingdom—Kvaser (embedded control system)
CCP/XCP (automotive ECU calibration)
GMLAN—General Motors (for General Motors)
RV-C—RVIA (used for recreational vehicles)
SafetyBUS p—Pilz (used for industrial automation)
UAVCAN (aerospace and robotics)

“Controller” generally refers to a mechanical or electronic device configured to control the behavior of another mechanical or electronic device. A controller may include a “control circuit” configured to provide signals or other electrical impulses that may be received and interpreted by the controlled device to indicate how it should behave.

“Control Logic” generally refers to hardware or software configured to implement an automatic decision making process by which inputs are considered, and corresponding outputs are generated. The output may be used for any suitable purpose such as to provide specific commands to machines or processes specifying specific actions to take. Examples of control logic include computer programs executed by a processor to accept commands from a user and generate output according to the logic implemented in the program as executed by the processor. In another example, control logic may be implemented as a series of logic gates, microcontrollers, and the like, electrically connected together in a predetermined arrangement so as to accept input from other circuits or computers and produce an output according to the rules implemented in the logic circuits.

“Current” generally refers to the rate of flow of electric charge past a point or region. An electric current is said to exist when there is a net flow of electric charge through a region. When an electric current flows in a suitably shaped conductor at radio frequencies, radio waves can be generated. These travel at about the speed of light and can cause electric currents in distant conductors. Electric currents cause Joule heating, and may be useful for creating magnetic fields.

“Data” generally refers to one or more values of qualitative or quantitative variables that are usually the result of measurements. Data may be considered “atomic” as being finite individual units of specific information. Data can also be thought of as a value or set of values that includes a frame of reference indicating some meaning associated with the values. For example, the number “2” alone is a symbol that absent some context is meaningless. The number “2” may be considered “data” when it is understood to indicate, for example, the number of items produced in an hour.

Data may be organized and represented in a structured format. Examples include a tabular representation using rows and columns, a tree representation with a set of nodes considered to have a parent-children relationship, or a graph representation as a set of connected nodes to name a few.

The term “data” can refer to unprocessed data or “raw data” such as a collection of numbers, characters, or other symbols representing individual facts or opinions. Data may be collected by sensors in controlled or uncontrolled environments, or generated by observation, recording, or by processing of other data. The word “data” may be used in a plural or singular form. The older plural form “datum” may be used as well.

“Electrically connected” generally refers to a configuration of two objects that allows electricity to flow between them or through them. In one example, two conductive materials are physically adjacent one another and are sufficiently close together so that electricity can pass between them. In another example, two conductive materials are in physical contact allowing electricity to flow between them.

“Electromagnetic Waves” generally refers to waves having a separate electrical and a magnetic component. The electrical and magnetic components of an electromagnetic wave oscillate in phase and are always separated by a 90 degree angle. Electromagnetic waves can radiate from a source to create electromagnetic radiation capable of passing through a medium or through a vacuum. Electromagnetic waves include waves oscillating at any frequency in the electromagnetic spectrum including, but not limited to, radio waves, visible and invisible light, X-rays, and gamma-rays.

“Ground” or “circuit ground” generally refers to a node in an electrical circuit that is designated as a reference node for other nodes in a circuit. It is a reference point in an electrical circuit from which voltages are measured, a common return path for electric current, and/or a direct physical connection to the Earth.

“Ground cable” generally refers to a cable electrically connecting to a circuit ground.

“Lamp” generally refers to an electrical device configured to emit or produce light using electrical power. The generated light may be in the visible range, ultraviolet, infrared, or other light. Example illumination technologies that may be employed in a lamp include, but are not limited to, incandescent, halogen, LED, fluorescent, carbon arc, xenon arc, metal-halide, mercury-vapor, sulfur, neon, sodium-vapor, or others.

“LED Lamp” generally refers to an electrical device that uses Light Emitting Diodes (LEDs) to produce light using electrical power. A lamp may include a single LED, or multiple LEDs.

“Light Emitting Diode” or “LED” generally refers to a diode that is configured to emit light when electrical power passes through it. The term may be used to refer to single diodes as well as arrays of LED's and/or grouped light emitting diodes. This can include the die and/or the LED film or other laminate, LED packages, said packages may include encapsulating material around a die, and the material, typically transparent, may or may not have color tinting and/or may or may not have a colored sub-cover. An LED can be a variety of colors, shapes, sizes and designs, including with or without heat sinking, lenses, or reflectors, built into the package.

“Local Interconnect Network (LIN)” generally refers to a network protocol used for communication between components in vehicles, usually by means of serial communication. LIN may be used also over the vehicle's battery power-line with a special LIN over DC powerline (DC-LIN) transceiver. Features of the protocol include, but are not limited to a single master, up to 16 slaves, Slave Node Position Detection (SNPD) that allows node address assignment after power-up, single wire communications greater than 19.2 Kbits/s with a bus length of 40 meters or less, guaranteed latency times, variable length of data frame (2, 4 and 8 byte frames), multi-cast reception with time synchronization, without crystals or ceramic resonators, data checksum and error detection, detection of defective nodes, and an operating voltage of 12V.

A LIN may be implemented as a single-wire network such as an asynchronous serial network described on ISO 9141. A microcontroller may generate all needed LIN data by software and is connected to the LIN network via a LIN transceiver. The LIN Master may use one or more predefined scheduling tables to start sending and receiving to the LIN bus. These scheduling tables contain relative timing information, where the message sending is initiated. One LIN Frame consists of the two parts header and response. The header is always sent by the LIN Master, while the response is sent by either one dedicated LIN-Slave or the LIN master itself.

Transmitted data within the LIN is transmitted serially as eight bit data bytes with one start bit, one stop-bit, and no parity (break field does not have a start bit and stop bit). Bit rates vary within the range of 1 kbit/s to 20 kbit/s, or more. Data on the bus is divided into recessive (logical HIGH) and dominant (logical LOW). The time normal is considered by the LIN Masters stable clock source, the smallest entity is one bit time (e.g. 52 μs at 19.2 kbit/s).

Data may be transferred across the bus in fixed form messages of selectable lengths. The master task may transmit a header that consists of a break signal followed by synchronization and identifier fields. The slaves may respond with a data frame that consists of between 2, 4 and 8 data bytes plus 3 bytes of control information. Frame types include, unconditional frame, Event-triggered frame, Sporadic frame, Diagnostic frame, User-defined frame, Reserved frame. One example of a standard LIN is maintained by the International Organization for Standardization (ISO) as ISO/AWI 17987

“Memory” generally refers to any storage system or device configured to retain data or information. Each memory may include one or more types of solid-sate electronic memory, magnetic memory, or optical memory, just to name a few. Memory may use any suitable storage technology, or combination of storage technologies, and may be volatile, nonvolatile, or a hybrid combination of volatile and nonvolatile varieties. By way of non-limiting example, each memory may include solid-sate electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM).

Memory can refer to Dynamic Random Access Memory (DRAM) or any variants, including static random access memory (SRAM), Burst SRAM or Synch Burst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (REDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM).

Memory can also refer to non-volatile storage technologies such as non-volatile read access memory (NVRAM), flash memory, non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Domain Wall Memory (DWM) or “Racetrack” memory, Nano-RAM (NRAM), or Millipede memory. Other non-volatile types of memory include optical disc memory (such as a DVD or CD ROM), a magnetically encoded hard disc or hard disc platter, floppy disc, tape, or cartridge media. The concept of a “memory” includes the use of any suitable storage technology or any combination of storage technologies.

“Metallic” generally refers to a material that includes a metal, or is predominately (50% or more by weight) a metal. A metallic substance may be a single pure metal, an alloy of two or more metals, or any other suitable combination of metals. The term may be used to refer to materials that include nonmetallic substances. For example, a metallic cable may include one or more strands of wire that are predominately copper sheathed in a polymer or other nonconductive material.

“Microcontroller” or “MCU” generally refers to a small computer on a single integrated circuit. It may be similar to, but less sophisticated than, a System on a Chip or “SoC”; an SoC may include a microcontroller as one of its components. A microcontroller may contain one or more CPUs (processor cores) along with memory and programmable input/output peripherals. Program memory in the form of ferroelectric RAM, NOR flash or OTP ROM may also be included on the chip, as well as a small amount of RAM. Microcontrollers may be designed for embedded applications, in contrast to the microprocessors used in personal computers or other general purpose applications consisting of various discrete chips.

Microcontrollers may be included in automatically controlled products and devices, such as automobile engine control systems, implantable medical devices, remote controls, office machines, appliances, power tools, toys and other embedded systems. An MCU may be configured to handle mixed signals thus integrating analog components needed to control non-digital electronic systems.

Some microcontrollers may use four-bit words and operate at frequencies as low as 4 kHz, for low power consumption (single-digit milliwatts or microwatts). They will generally have the ability to retain functionality while waiting for an event such as a button press or other interrupt; power consumption while sleeping (CPU clock and most peripherals off) may be just nanowatts, making many of them well suited for long lasting battery applications. Other microcontrollers may serve performance roles, where they may need to act more like a Digital Signal Processor (DSP), with higher clock speeds and power consumption. A micro-controller may include any suitable combination of circuits such as:
1. a central processing unit—ranging from small and simple processors with registers as small as 4 bits or list, to complex processors with registers that are 32, 64, or more bits
2. volatile memory (RAM) for data storage
3. ROM, EPROM, EEPROM or Flash memory for program and operating parameter storage
4. discrete input and output bits, allowing control or detection of the logic sate of an individual package pin
5. serial input/output such as serial ports (UARTs)
6. other serial communications interfaces like I²C, Serial Peripheral Interface and Controller Area Network for system interconnect
7. peripherals such as timers, event counters, PWM generators, and watchdog
8. clock generator—often an oscillator for a quartz timing crystal, resonator or RC circuit
9. many include analog-to-digital converters, some include digital-to-analog converters
10. in-circuit programming and in-circuit debugging support

“Movement Sensor” or “Motion Sensor” generally refers to a device operable to detect motion or movement. Examples include the sensors that include an optical, microwave, and/or acoustic receiver and optionally, a transmitter as well. The transmitter and receiver may be mounted together, or mounted remotely from one another. In other examples, movement or motion may be determined by an accelerometer, by tracking signals from navigational equipment such as GPS, cellular, and the like, or by any other suitable means.

“Multiple” as used herein is synonymous with the term “plurality” and refers to more than one, or by extension, two or more.

“Network” or “Computer Network” generally refers to a telecommunications network that allows computers to exchange data. Computers can pass data to each other along data connections by transforming data into a collection of datagrams or packets. The connections between computers and the network may be established using either cables, optical fibers, or via electromagnetic transmissions such as for wireless network devices.

Computers coupled to a network may be referred to as “nodes” or as “hosts” and may originate, broadcast, route, or accept data from the network. Nodes can include any computing device such as personal computers, phones, servers as well as specialized computers that operate to maintain the flow of data across the network, referred to as “network devices”. Two nodes can be considered “networked together” when one device is able to exchange information with another device, whether or not they have a direct connection to each other.

Examples of wired network connections may include Digital Subscriber Lines (DSL), coaxial cable lines, or optical fiber lines. The wireless connections may include BLUETOOTH, Worldwide Interoperability for Microwave Access (WiMAX), infrared channel or satellite band, or any wireless local area network (Wi-Fi) such as those implemented using the Institute of Electrical and Electronics Engineers' (IEEE) 802.11 standards (e.g. 802.11(a), 802.11(b), 802.11(g), or 802.11(n) to name a few). Wireless links may also include or use any cellular network standards used to communicate among mobile devices including 1G, 2G, 3G, or 4G. The network standards may qualify as 1G, 2G, etc. by fulfilling a specification or standards such as the specifications maintained by International Telecommunication Union (ITU). For example, a network may be referred to as a “3G network” if it meets the criteria in the International Mobile Telecommunications-2000 (IMT-2000) specification regardless of what it may otherwise be referred to. A network may be referred to as a “4G network” if it meets the requirements of the International Mobile Telecommunications Advanced (IMTAdvanced) specification. Examples of cellular network or other wireless standards include AMPS, GSM, GPRS, UMTS, LTE, LTE Advanced, Mobile WiMAX, and WiMAX-Advanced.

Cellular network standards may use various channel access methods such as FDMA, TDMA, CDMA, or SDMA. Different types of data may be transmitted via different links and standards, or the same types of data may be transmitted via different links and standards.

The geographical scope of the network may vary widely. Examples include a body area network (BAN), a personal area network (PAN), a low power wireless Personal Area Network using IPv6 (6LoWPAN), a local-area network (LAN), a metropolitan area network (MAN), a wide area network (WAN), or the Internet.

A network may have any suitable network topology defining the number and use of the network connections. The network topology may be of any suitable form and may include point-to-point, bus, star, ring, mesh, or tree. A network may be an overlay network which is virtual and is configured as one or more layers that use or “lay on top of” other networks.

A network may utilize different communication protocols or messaging techniques including layers or stacks of protocols. Examples include the Ethernet protocol, the internet protocol suite (TCP/IP), the ATM (Asynchronous Transfer Mode) technique, the SONET (Synchronous Optical Networking) protocol, or the SDE1 (Synchronous Digital Elierarchy) protocol. The TCP/IP internet protocol suite may include application layer, transport layer, internet layer (including, e.g., IPv6), or the link layer.

“Optionally” as used herein means discretionary; not required; possible, but not compulsory; left to personal choice.

“Predominately” as used herein is synonymous with greater than 50%.

“Processor” generally refers to one or more electronic components configured to operate as a single unit configured or programmed to process input to generate an output. Alternatively, when of a multi-component form, a processor may have one or more components located remotely relative to the others. One or more components of each processor may be of the electronic variety defining digital circuitry, analog circuitry, or both. In one example, each processor is of a conventional, integrated circuit microprocessor arrangement, such as one or more PENTIUM, i3, i5 or i7 processors supplied by INTEL Corporation of Santa Clara, California, USA. Other examples of commercially available processors include but are not limited to the X8 and Freescale Coldfire processors made by Motorola Corporation of Schaumburg, Illinois, USA; the ARM processor and TEGRA System on a Chip (SoC) processors manufactured by Nvidia of Santa Clara, California, USA; the POWER7 processor manufactured by International Business Machines of White Plains, New York, USA; any of the FX, Phenom, Athlon, Sempron, or Opteron processors manufactured by Advanced Micro Devices of Sunnyvale, California, USA; or the Snapdragon SoC processors manufactured by Qualcomm of San Diego, California, USA.

A processor also includes Application-Specific Integrated Circuit (ASIC). An ASIC is an Integrated Circuit (IC) customized to perform a specific series of logical operations is controlling a computer to perform specific tasks or functions. An ASIC is an example of a processor for a special purpose computer, rather than a processor configured for general-purpose use. An application-specific integrated circuit generally is not reprogrammable to perform other functions and may be programmed once when it is manufactured.

In another example, a processor may be of the “field programmable” type. Such processors may be programmed multiple times “in the field” to perform various specialized or general functions after they are manufactured. A field-programmable processor may include a Field-Programmable Gate Array (FPGA) in an integrated circuit in the processor. FPGA may be programmed to perform a specific series of instructions which may be retained in nonvolatile memory cells in the FPGA. The FPGA may be configured by a customer or a designer using a hardware description language (HDL). In FPGA may be reprogrammed using another computer to reconfigure the FPGA to implement a new set of commands or operating instructions. Such an operation may be executed in any suitable means such as by a firmware upgrade to the processor circuitry.

Just as the concept of a computer is not limited to a single physical device in a single location, so also the concept of a “processor” is not limited to a single physical logic circuit or package of circuits but includes one or more such circuits or circuit packages possibly contained within or across multiple computers in numerous physical locations. In a virtual computing environment, an unknown number of physical processors may be actively processing data, the unknown number may automatically change over time as well.

The concept of a “processor” includes a device configured or programmed to make threshold comparisons, rules comparisons, calculations, or perform logical operations applying a rule to data yielding a logical result (e.g. “true” or “false”). Processing activities may occur in multiple single processors on separate servers, on multiple processors in a single server with separate processors, or on multiple processors physically remote from one another in separate computing devices.

“Portion” means a part of a whole, either separated from or integrated with it.

“Power Cable” generally refers to a cable configured to transfer electrical power as part of an electrical circuit. A power cable may be used exclusively to transfer power, or it may be used to also transfer signals, such as in the case of a Power Line Communication (PLC) system.

“Power Line Communication (PLC)” generally refers to a system of electronic communication that transmits and receives signals on the same circuit used to transfer power. Examples including system that send data over common AC wiring in a home, or Broadband over Power Line (BPL) systems for carrying network traffic over high voltage transmission lines, as well as systems for in-vehicle communications.

In the vehicle context, data, voice, music and video signals may be transferred to throughout a vehicle by over direct current DC battery power-line. One example of is DC-BU, a technology for reliable and economical communication over noisy DC or AC power lines. Digital input data may be modulated and carried over the power line and then demodulated into the original digital data up receipt.

In DC-BUS or other PLC implementations, the signaling technology is byte oriented, allowing transfer of a single UART data byte or more over noisy channel (such as the powerline) at bit-rate up to 115.2 kbit/s, each transmitted byte is protected against errors caused by noisy environment. This method may operate on a channel ranging in the HF band. A narrow band signaling modulation may be used that is based on a combination of phase changes to transfer each byte. There is no restriction to the number of bytes. Any Universal Asynchronous Receiver-Transmitter (UART) based standards such as RS-232, RS-485 and LIN-bus can use a DC-BUS as a physical layer (as referred to in the OSI model).

“Sensor” generally refers to a transducer configured to sense or detect a characteristic of the environment local to the sensor. For example, sensors may be constructed to detect events or changes in quantities or sensed parameters providing a corresponding output, generally as an electrical or electromagnetic signal. A sensor's sensitivity indicates how much the sensor's output changes when the input quantity being measured changes.

“Sense parameter” generally refers to a property of the environment detectable by a sensor. As used herein, sense parameter can be synonymous with an operating condition, environmental factor, sensor parameter, or environmental condition. Sense parameters may include temperature, air pressure, speed, acceleration, the presence or intensity of sound or light or other electromagnetic phenomenon, the strength and/or orientation of a magnetic or electrical field, and the like.

“Signal” generally refers to a function or means of representing information. It may be thought of as the output of a transformation or encoding process. The concept generally includes a change in the state of a medium or carrier that conveys the information. The medium can be any suitable medium such as air, water, electricity, magnetism, or electromagnetic energy such as in the case of radio waves, pulses of visible or invisible light, and the like.

As used herein, a “signal” implies a representation of meaningful information. Arbitrary or random changes in the state of a carrier medium are generally not considered “signals” and may be considered “noise”. For example, arbitrary binary data streams are not considered as signals. On the other hand, analog and digital signals that are representations of analog physical quantities are examples of signals. A signal is commonly not useful without some way to transmit or send the information, and a receiver responsive to the transmitter for receiving the information.

In a communication system, for example, a transmitter encodes a message to a signal, which is carried to a receiver by the communications channel. For example, the words “The time is 12 o'clock” might be the message spoken into a telephone. The telephone transmitter may then convert the sounds into an electrical voltage signal. The signal is transmitted to the receiving telephone by wires, at the receiver it is reconverted into sounds.

Signals may be thought of as “discrete” or “continuous.” Discrete-time signals are often referred to as time series in other fields. Continuous-time signals are often referred to as continuous signals even when the signal functions are not continuous, such as in a square-wave signal.

Another categorization is signals which are “discrete-valued” and “continuous-valued”. Particularly in digital signal processing a digital signal is sometimes defined as a sequence of discrete values, that may or may not be derived from an underlying continuous-valued physical process. In other contexts, digital signals are defined as the continuous-time waveform signals in a digital system, representing a bit-stream. In the first case, a signal that is generated by means of a digital modulation method may be considered as converted to an analog signal, while it may be considered as a digital signal in the second case.

“Socket” generally refers a device into which something fits in order to electrically and/or physically connect another electrical device to a circuit.

“Stop-tail-turn Lamp” or “STT Lamp” generally refers to a lamp which is compliant with present legal and/or regulatory requirements for a truck or a trailer such as illuminated surface area, candela, and otherwise. Such regulations include, for example, Title 49 of the U.S. Code of Federal Regulations, section 571.108, also known as Federal Motor Vehicle Safety Standard (FMVSS) 108.

“Terminal” generally refers to a plug, socket or other connection (male, female, mixed, hermaphroditic, or otherwise) for mechanically and electrically connecting two or more wires or other conductors.

“Trailer” generally refers to a vehicle that is configured to be moved about using some other vehicle coupled to the trailer.

“Truck” generally refers to a powered truck (also known as a tractor or cab) for pulling a trailer.

“Vehicle” generally refers to a self-propelled or towed device for transportation, including without limitation, car, truck, bus, boat, tank or other military vehicle, airplane, truck trailer, truck cab, boat trailer, other trailer, emergency vehicle, and motorcycle.

What is claimed is:

1. A security seal for a trailer door, comprising:
an electrically conductive security cable;
first and second connection terminal mounted to the security cable;
a resistor electrically connected in series with the cable between the first and second terminals;
wherein the first and second connection terminals are arranged and configured to electrically connect to corresponding first and second analog input connectors of an adapter that further includes:
a third connector having at least four metal pins adapted for receiving both electrical power and digital electrical signals; and
a control circuit electrically connected to the at least four terminals, and to the first and second analog input terminals, wherein the control circuit is operable to monitor the electrical continuity of the electrically conductive security cable electrically connected to the first and second input terminals.

2. The security seal of claim 1, wherein the control circuit includes a memory storing an identifier that distinguishes the adapter from other adapters of other security seals.

3. The security seal of claim 1, wherein the control circuit is configured to use the terminals of the third connector to send signals reporting the electrical continuity between the first and second input terminals.

4. The security seal of claim 3, wherein the control circuit is configured to use the terminals of the third connector to send a security alert when the electrical continuity is broken between the first and second input terminals.

5. The security seal of claim the security seal of claim 1, wherein the first and second analog input connectors define cavities arranged and configured to receive different ends of the security cable.

6. The security seal of claim the security seal of claim 1, wherein the first and second connection terminals are selectively matable and unmatable with the first and second analog input connectors, and wherein the first and second analog input connectors include a retention mechanism for retaining the first and second connection terminals adjacent to the first and second analog input connectors.

7. The security seal of claim 1, wherein the first connection terminal is mounted at a first end of the security cable, and wherein the second connection terminal is mounted at a second and of the security cable that is different from the first end.

8. The security seal of claim 1, wherein monitoring the electrical continuity includes determining the combined resistance of the cable and the resistor.

9. The security seal of claim 1, wherein the security cable includes an insulative layer around at least a portion of the conductive security cable.

10. The security seal of claim 1, wherein the security cable is arranged and configured to pass through a portion of a locking assembly for a trailer door of a truck trailer.

11. The security seal of claim 1, wherein the control circuit includes:
a transceiver that is arranged and configured to receive the digital electrical signals from the third connector via an electrical connection with at least one digital input pin of the third connector, and wherein the transceiver includes at least one data output terminal.

12. The security seal of claim 11, wherein the control circuit includes:
a microcontroller that has at least one input terminal electrically connected to the at least one data output terminal of the transceiver.

13. The security seal of claim 11, wherein the transceiver includes:
a Control Area Network (CAN) controller and a CAN transceiver electrically connected to the CAN controller and the data output terminal of the transceiver; and
wherein the CAN transceiver is responsive to commands received from a master control circuit in the trailer.

14. The security seal of claim 1, wherein the digital electrical signals conform to the Control Area Network (CAN) protocol.

15. The security seal of claim 1, wherein the at least four metal pins include a power pin, a ground pin, and two data pins.

16. The security seal of claim 1, wherein the third connector is arranged and configured to couple to a corresponding connector of the trailer, wherein the corresponding connector is electrically connected to a master control circuit via data cables configured to deliver the digital electrical signals, and wherein the master control circuit is configured to receive data about the electrical continuity of the security cable and to report a state of the security seal to a remote server.

17. The security seal of claim 16, wherein the master control circuit is configured to send an alert to the remote server when the electrical connection between the adapter and the master control circuit is lost.

18. The security seal of claim 16, wherein the master control circuit is configured to send an alert to the remote server when the electrical continuity of the security cable is broken.

19. The security seal of claim 18, wherein the control circuit in the adapter is operable to generate and send the alert to the master control circuit.

20. A trailer security system, comprising:
a security seal including a cable and a first and second connector electrically connected to the cable;
an adapter that includes:
first and second input connectors electrically connected to the first and second connectors of the security seal;
a third connector having at least four metal pins adapted for receiving both electrical power and digital electrical signals, the third connector electrically connected to the trailer; and
an adapter control circuit electrically connected to the at least four metal pins, and to the first and second analog input terminals, wherein the adapter control circuit is operable to monitor the electrical continuity of the security cable via the first and second input terminals;
a remote monitoring system executing on one or more processors of one or more computers;
a master control circuit in the trailer, wherein the master control circuit is in communication with the adapter control circuit in the adapter, and with the remote monitoring system via one or more communication links;
wherein the adapter control circuit is configured to send status updates to the master control circuit indicating the state of the security seal;
wherein the master control circuit is configured to accept the status updates and to generate a security update and send it to the remote monitoring service via a communication link with the remote monitoring service;
wherein the remote monitoring system is configured to receive security updates from the master control circuit and to send an alert message to a personal computing device when the security update indicates the security seal has been broken.

21. The trailer security system of claim 20, wherein the cable is operable to pass through at least a portion of a locking assembly of the trailer, and wherein the locking assembly is arranged and configured to selectively hold a door of the trailer in a locked state.

22. The trailer security system of claim 20, wherein the master control circuit is configured to send an alert to the remote monitoring system when the electrical continuity of the security cable is broken.

23. The trailer security system of claim 20, wherein the master control circuit is configured to send an alert to the remote monitoring system when the electrical connection between the adapter and the master control circuit is lost.

24. The trailer security system of claim 20, wherein the adapter control circuit is operable to send an alert to the master control circuit when the electrical continuity of the security cable is broken.

25. The trailer security system of claim 20, wherein the remote monitoring system is configured receive an alert sent from the master control circuit and to send a corresponding security notification to one or more other computing devices.
